(19) United States
(12) Patent Application Publication
(10) Pub. No.: US 2021/0021359 A1
(43) Pub. Date: Jan. 21, 2021

(54) INFORMATION PROCESSING DEVICE, INFORMATION PROCESSING METHOD, AND PROGRAM

(71) Applicant: SONY CORPORATION, TOKYO (JP)

(72) Inventors: KOUICHI UCHIMURA, KANAGAWA (JP); KENJIRO UEDA, KANAGAWA (JP); TAKEHIKO NAKANO, KANAGAWA (JP)

(21) Appl. No.: 16/982,586

(22) PCT Filed: Mar. 12, 2019
(86) PCT No.: PCT/JP2019/010023

§ 371 Date: Sep. 20, 2020

(30) Foreign Application Priority Data
Mar. 28, 2018 (JP) 2018-062934

(51) Int. Cl. H04H 60/18; H04H 60/23; H04N 21/436; H04N 21/8355

(52) U.S. Cl. CPC H04H 60/18; H04N 21/8355; H04N 21/436; H04H 60/23

(57) ABSTRACT

To enable copy control according to original copy control information at a data output destination by converting copy control information defined in MMT format data into copy control information defined by DTCP and transmitting the converted copy control information to a network-connected device. The copy control information defined in the MMT format data is converted into the copy control information defined by DTCP and transmitted to the network-connected device. In the case where the transmission data is any of a 4K image, an 8K image, or an HDR image, and in a case where the copy control information defined by DTCP2 and the transmission data are images are 2K images or SDR images, the copy control information defined by DTCP1 is generated and recorded in a control information storage packet or a program map table (PMT) to be transmitted to a network-connected device, and transmitted.

### TECHNICAL FIELD

The present disclosure relates to an information processing device, an information processing method, and a program. More specifically, the present disclosure relates to an information processing device, an information processing method, and a program for enabling execution of copy control taking over copy control information compatible with MPEG media transport (MMT) in another device at data transmission destination in a case where a reception device, which receives MMT data scheduled to be standardized as a data transmission standard for, for example, future broadcast waves, transmits received data to the another device.

### BACKGROUND ART

Currently, standardization for realizing high-image quality video data transmission such as broadcasting of 4K images, 8K images, and the like is in progress, and study of a data distribution method using an MPEG media transport (MMT) format is in progress as one of such standardizations.

The MMT format defines a data transfer method (transport format) for transmitting, via a broadcast wave or a network, for example, coded data configuring content such as videos, audios, and subtitles, and data of control information (signaling information (SI)) including various types of management information such as control information and attribute information.

The MMT format is scheduled to be used for, for example, broadcasting next-generation content such as 4K images, high dynamic range (HDR) images, and the like.

Note that a conventional technology disclosing data reception and data processing according to the MMT format includes, for example, Patent Document 1 (International Publication WO2018/016294).

Many of broadcast content are content protected by copyright, and various types of copy control information are set in units of content such as in units of program.

For example, various types of copy control information are set in units of content (program) such as copy-allowed content, copy-prohibited content, or content in which an allowable copy number or count is set.

These various types of copy control information regarding the broadcast content are stored in a packet (TLV packet/MMTP packet) transmitted via the broadcast wave together with program content, and transmitted to the reception device on a user side.

The reception device performs copy processing according to the copy control information stored in the packet (TLV packet/MMTP packet) according to the MMT format.

However, in a case of outputting the data received by the reception device to, for example, a device other than the reception device that has performed the processing of receiving the broadcast wave, such as another network-connected device in a house like a personal computer (PC) or a recording and reproducing device (recorder), the reception device converts the MMT format into another format, such as an MPEG-2TS format or MP4 and transfers the data This is because, for example, the MPEG-2TS format or MP4 is often used as a current transmission format for videos, audios, subtitles, and the like, or as a current data recording format for media, and many of network-connected devices that are data output destinations cannot process the MMT format data.

When the format conversion of the data received by the reception device is performed when outputting the received data to the network-connected device, the copy control information set for the MMT format data is not taken over, and there is a possibility that the network-connected device as a data output destination executes disordered copy.

### CITATION LIST

### Patent Document

### Patent Document 1: International Publication WO2018/016294

### SUMMARY OF THE INVENTION

### Problems to be Solved by the Invention

The present disclosure has been made in view of the above-described problem, for example, and an object is to provide an information processing device, an information processing method, and a program for enabling copy control that takes over copy control information compatible with MMT in a network-connected device in a case where data according to an MMT format is output from a receiver that receives the data to the network-connected device.

### Solutions to Problems

The first aspect of the present disclosure resides in

an information processing device including

a data processing unit configured to input MPEG media transport (MMT) format data in which copy control information is set, execute format conversion, and generate transmission data to be transmitted to a network-connected device, in which

the data processing unit

acquires the copy control information compatible with the MMT format data included in input data, and generates the transmission data including the copy control information defined by digital transmission content protection (DTCP).

Moreover, the second aspect of the present disclosure resides in

an information processing method executed in an information processing device,

the information processing device including

a data processing unit configured to input MPEG media transport (MMT) format data in which copy control information is set, execute format conversion, and generate transmission data to be transmitted to a network-connected device,

the information processing method including

by the data processing unit,

acquiring the copy control information compatible with the MMT format data included in input data, and generating the transmission data including the copy control information defined by digital transmission content protection (DTCP).

Moreover, the third aspect of the present disclosure resides in

a program for causing an information processing device to execute information processing,

the information processing device including

a data processing unit configured to input MPEG media transport (MMT) format data in which copy control information is set, execute format conversion, and generate transmission data to be transmitted to a network-connected device,

the program causing the data processing unit

to acquire the copy control information compatible with the MMT format data included in input data, and generate the transmission data including the copy control information defined by digital transmission content protection (DTCP).

Note that the program of the present disclosure is, for example, a program that can be provided by a storage medium or a communication medium provided in a computer readable format to an information processing device or a computer system that can execute various program codes. By providing such a program in the computer readable format, processing according to the program is realized on the information processing device or the computer system.

Still other objects, features, and advantages of the present disclosure will become clear from more detailed description based on embodiments and attached drawings of the present disclosure described below. Note that a system in the present specification is a logical aggregate configuration of a plurality of devices, and is not limited to devices having respective configurations within the same housing.

### Effects of the Invention

According to the configuration of an embodiment of the present disclosure, a configuration for enabling copy control according to original copy control information at a data output destination is implemented by converting copy control information defined in MMT format data into copy control information defined by DTCP and transmitting the converted copy control information to a network-connected device.

Specifically, for example, the copy control information defined in the MMT format data is converted into the copy control information defined by DTCP and transmitted to the network-connected device. In a case where the transmission data is any of a 4K image, an 8K image, or an HDR image, and in a case where the copy control information defined by DTCP2 and the transmission data are images equal to or less than 2K and further, are standard dynamic range (SDR) images, the copy control information defined by DTCP1 is generated and recorded in a control information storage packet or a program map table (PMT) to be transmitted to a network-connected device, and transmitted.

With the present configuration, a configuration for enabling copy control according to original copy control information at a data output destination is implemented by converting copy control information defined in MMT format data into copy control information defined by DTCP and transmitting the converted copy control information to a network-connected device.

Note that the effects described in the present specification are merely examples and are not limited, and additional effects may be exhibited.

### BRIEF DESCRIPTION OF DRAWINGS

FIG. 1 is a diagram for describing a problem in processing of transmitting broadcast content via a network.

FIG. 2 is a diagram for describing an outline of a configuration and processing of the present disclosure.

FIG. 3 is a diagram for describing an outline of a configuration and processing of the present disclosure.

FIG. 4 is a diagram for describing an MMT format.

FIG. 5 is a diagram for describing a TLV packet according to the MMT format transmitted by a transmission device such as a broadcasting station.

FIG. 6 is a diagram for describing an MMTP packet that stores a service description table (MH-SDT).

FIG. 7 is a diagram for describing a specific data configuration of the service description table (MH-SDT).

FIG. 8 is a diagram for describing a data configuration (Syntax) of a content copy control descriptor.

FIG. 9 is a diagram for describing a data configuration (Syntax) of a content use control descriptor.

FIG. 10 is a diagram illustrating a list of types (five types) of digital copy control modes and settings of three types of control information defined in the MMT format.

FIG. 11 is a diagram for describing processing of converting copy control information compatible with the MMT format into copy control information of DTCP2.

FIG. 12 is a diagram for describing a data configuration (Syntax) of a CMI descriptor stored in a control information storage packet (CMI) 101.

FIG. 13 is a diagram for describing main copy control information recorded in a content control information recording area.

FIG. 14 is a diagram for describing mapping processing of converting the copy control information compatible with the MMT format into the copy control information defined by DTCP2.

FIG. 15 is a diagram for describing a data recording example of the content control information.

FIG. 16 is a diagram for describing processing of converting copy control information compatible with the MMT format into copy control information of DTCP1.

FIG. 17 is a diagram for describing the content control information recording area.

FIG. 18 is a diagram for describing a program map table (PMT).

FIG. 19 is a diagram for describing a data configuration (Syntax) of a DTCP descriptor (DTCP_descriptor).

FIG. 20 is a diagram for describing a recording example of the copy control information.

FIG. 21 is a diagram for describing mapping processing of converting the copy control information compatible with the MMT format into the copy control information defined by DTCP1.

FIG. 22 is a diagram for describing a recording example of the content control information to be recorded in the program map table (PMT).

FIG. 23 is a diagram for describing a recording example of the content control information to be recorded in a PCP header.

FIG. 24 is a diagram for describing a copy control information conversion processing example corresponding to a specific example of data transmission.

FIG. 25 is a diagram for describing a copy control information conversion processing example corresponding to a specific example of data transmission.

FIG. 26 is a diagram for describing a copy control information conversion processing example corresponding to a specific example of data transmission.

FIG. 27 is a diagram for describing a copy control information conversion processing example corresponding to a specific example of data transmission.

FIG. 28 is a diagram for describing a copy control information conversion processing example corresponding to a specific example of data transmission.

FIG. 29 is a diagram for describing a copy control information conversion processing example corresponding to a specific example of data transmission.

FIG. 29 is a diagram illustrating a device configuration example of a first information processing device (DTCP source).

FIG. 30 is a flowchart illustrating a processing sequence of processing executed by the information processing device.

FIG. 31 is a diagram for describing a hardware configuration example of an information processing device applied to the processing of the present disclosure.

### MODE FOR CARRYING OUT THE INVENTION

Hereinafter, an information processing device, an information processing method, and a program of the present disclosure will be described in detail with reference to the drawings. Note that the description will be given according to the following items.

1. Reception of MMT format data and output mode to network-connected device, and problems

2. Outline of processing of present disclosure

3. MPEG media transport (MMT) format

4. Copy control information set in MMT format data

5. Processing of converting copy control information compatible with MMT format into copy control information of DTCP2

6. Processing of converting copy control information compatible with MMT format into copy control information of DTCP1

7. Conversion processing and transmission example of copy control information corresponding to specific example of data transmission

8. Configuration and processing of information processing device for executing data recording processing for information recording medium

9. Configuration example of information processing device

10. Conclusion of configurations of present disclosure

[1. Reception of MMT Format Data and Output Mode to Network-Connected Device, and Problems]

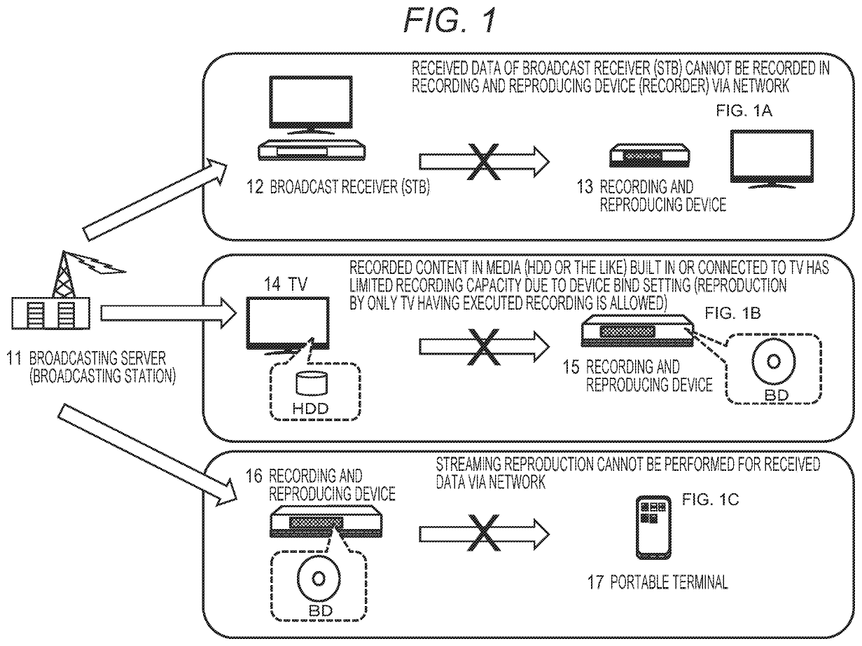

First, reception of MPEG media transport (MMT) format data and output modes to a network-connected device, and problems will be described with reference to FIG. 1.

A broadcasting server 11 illustrated in FIG. 1 is, for example, a broadcasting station. The broadcasting server 11 transmits data according to an MMT format.

As described above, the MMT format is a data transmission standard proposed for implementing high-image quality video data transmission such as broadcasting of, for example, 4K images and 8K images.

The MMT format defines a data transfer method (transport format) for transmitting, via a broadcast wave or a network, for example, coded data configuring content such as videos, audios, and subtitles, and data of control information (signaling information (SI)) including various types of management information such as control information and attribute information.

Many of broadcast content are content protected by copyright, and various types of copy control information are set in units of content such as in units of program. For example, various types of copy control information are set in units of content (program) such as copy-allowed content, copy-prohibited content, or content in which an allowable copy number or count is set.

These various types of copy control information regarding the broadcast content are stored in a packet (TLV packet/MMTP packet) transmitted via the broadcast wave together with program content, and transmitted to the reception device on a user side.

FIG. 1 illustrates a broadcast receiver (set top box (STB)) 12, a TV 14, and a recording and reproducing device 17, as devices (reception devices) that receive the MMT format data.

These reception devices can understand the MMT format, acquire content including videos, audios, and the like stored according to the MMT format, and output the content to a TV or a medium.

In these reception devices, copy processing according to the copy control information stored in the packet (TLV packet/MMTP packet) according to the MMT format are performed.

However, in the case of outputting the data received by the reception device to, for example, a device other than the reception device that has performed the processing of receiving the broadcast wave, such as another network-connected device in a house, like a personal computer (PC) or a recording and reproducing device (recorder), the reception device converts the MMT format into another format, such as an MPEG-2TS format or MP4 and transfers the data This is because, for example, the MPEG-2TS format, MP4, or the like is often used as the current transmission format for videos, audios, and subtitles or as the current data recording format for media, and many of network-connected devices that are data output destinations cannot process the MMT format data.

When the format conversion of the data received by the reception device is performed when outputting the received data to the network-connected device, the copy control information set for the MMT format data is not taken over, and there is a possibility that the network-connected device as a data output destination executes disordered copy.

To prevent occurrence of such a state, currently, processing of prohibiting or restricting output of the data received by the reception device to the network-connected device is performed. Specifically, for example, processing (1) to (3) illustrated in FIG. 1 is prohibited or restricted.

The processing (1) to (3) in FIG. 1 will be described.

FIG. 1(1) illustrates an example of a case of outputting received data of the broadcast receiver (STB) 12 to the recording and reproducing device (recorder) 13 via a network, and copying or moving and recording broadcast content in the recording and reproducing device (recorder) 13. Currently, this processing is prohibited.

FIG. 1(2) illustrates an example of a case of recording the broadcast content in a medium (HDD or the like) built in or connected to the TV 14. The recorded content has a device bind setting (reproduction is allowed only by a recording-execution TV) and can be reproduced only by the TV that has executed the recording.

However, an HDD has a limited recording capacity, and thus there is a high possibility of occurrence of a demand of outputting old recorded content to another device, such as a recording and reproducing device 15 via the network in order to record new content. However, the old recorded content cannot be recorded in a BD or the like under the current rule.

FIG. 1(3) illustrates an example in which a recording and reproducing device 16 that has received a broadcast wave records the broadcast wave in a medium (BD), and a portable terminal 17 receives the recorded data and performs streaming reproduction for the recorded data via a network. Currently, such content output is also prohibited.

Such prohibition of the processing and the restriction processing are due to a concern about a possibility that, when the reception device that has received the MMT format data outputs data to a network-connected device, the reception device converts the MMT format data into another format, at the conversion, the copy control information associated with the MMT format data is lost, and disordered copy or the like is performed at the data output destination.

[2. Outline of Processing of Present Disclosure]

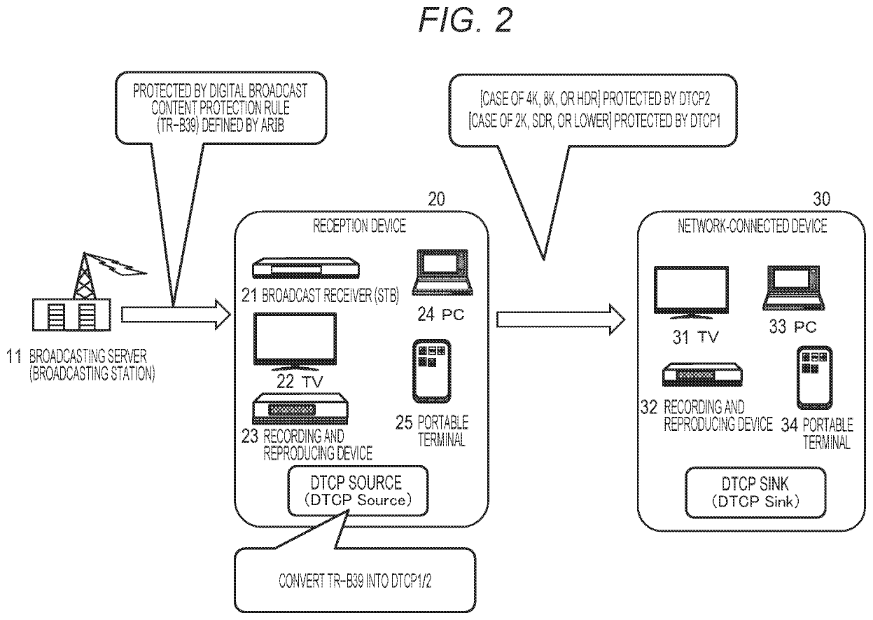

Next, an outline of processing of the present disclosure will be described with reference to FIG. 2 and the subsequent drawings.

In the processing of the present disclosure, when a reception device that receives broadcast content outputs the received broadcast content to a network-connected device, the reception device converts copy control information compatible with the MMT format associated with the broadcast content into the copy control information defined by digital transmission content protection (DTCP), and outputs the copy control information.

The network-connected device executes copy control processing according to the copy control information defined by DTCP.

By performing such processing, the copy control information compatible with the MMT format associated with the broadcast content can be taken over to the device at the data output destination.

DTCP is a technology that defines specifications such as a communication protocol for preventing illegal copy of content in a network. DTCP is a content protection technology that is also used in an MPEG-2TS format, MP4, and the like used as a data transmission format or a recording format.

An outline of the processing of the present disclosure will be described with reference to FIG. 2.

FIG. 2 illustrates the broadcasting server 11 such as a broadcasting station, a reception device 20, and a network-connected device 30.

The broadcasting server 11 such as a broadcasting station transmits data according to the MMT format.

In the MMT format data, the copy control information according to the content protection rule (TR-B39) regulated by Association of Radio Industries and Businesses (ARIB) is recorded.

In a case of performing copy processing or move processing (moving processing) for the MMT format data received from the broadcasting server 11 or performing recording processing for a medium, the reception device 20 performs the processing according to the content protection rule (TR-B39) defined by ARIB.

Note that FIG. 2 illustrates, as examples of the reception device 20, a broadcast receiver (set top box (STB)) 21, a TV 22, a recording and reproducing device 23, a PC 24, and a portable terminal 25. These are examples, and various types of reception devices 20 are available in addition to the above examples.

All of these devices are devices capable of understanding MMT format data and performing data processing of the MMT format data.

These reception devices 20 transmit broadcast content to the network-connected device 30 via a communication network such as a home network and the like.

In the processing of transmitting the broadcast content, the reception devices 20 convert the copy control information defined by ARIB compatible with the MMT format into the copy control information defined by DTCP, and transmit the converted copy control information together with the transmitted content.

Note that a transmission device for content protected by the content protection technology according to DTCP is called DTCP source, and a reception device for content protected by the content protection technology according to DTCP is called DTCP sink.

FIG. 2 illustrates a TV 31, a recording and reproducing device 32, a PC 33, and a portable terminal 34, as network-connected devices (DTCP sinks) 30. Various network-connected devices are available as the DTCP sinks, in addition to the above devices.

When using content (DTCP content) received from the reception device (DTCP source), the network-connected device (DTCP sink) 30 executes processing according to the copy control information recorded according to the DTCP rule.

The copy control information is data obtained by the reception device (DTCP source) 20 converting the copy control information into the copy control information defined by DTCP on the basis of the copy control information defined by ARIB compatible with the MMT format. Therefore, the network-connected device (DTCP sink) 30 can perform copy control taking over the copy control information defined by ARIB compatible with the MMT format.

Note that there are currently two different types of DTCP: DTCP1 and DTCP2.

DTCP2 is a content protection technology rule for high-image quality content such as 4K content, 8K content, and high dynamic range (HDR) content.

Meanwhile, DTCP1 is a content protection technology rule for 2K content, standard dynamic range (SDR) content, and the like.

In the case where the transmitted content for the network-connected device (DTCP sink) 30 is high-image quality content such as 4K content, 8K content, or HDR content, the reception device (DTCP source) 20 transmits the copy control information defined by DTCP2 in association with the content.

Meanwhile, in the case where the transmitted content to the network-connected device (DTCP sink) 30 is 2K content and is standard dynamic range (SDR) content, the reception device (DTCP source) 20 transmits the copy control information defined by DTCP1 in association with the content.

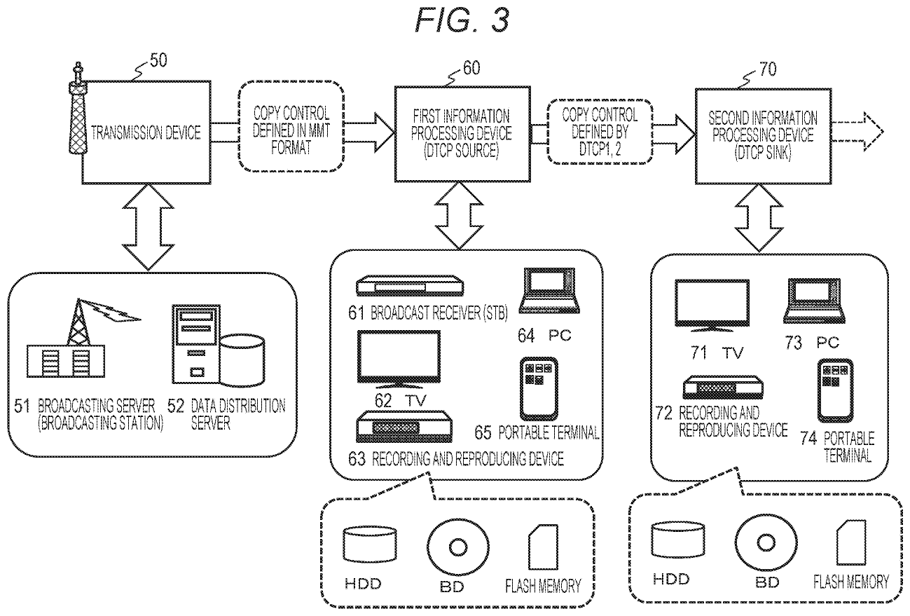

FIG. 3 illustrates a diagram summarizing the processing of the present disclosure.

FIG. 3 illustrates a transmission device 50, a first information processing device (DTCP source) 60, and a second information processing device (DTCP sink) 70.

The transmission device 50 includes a broadcasting server 51 such as a broadcasting station and a data distribution server 52. These transmission devices 50 transmit broadcast content or the like as MMT format data. Note that the transmitted content is not necessarily limited to real-time broadcast content but includes re-distribution content, non-broadcast content, cable television distribution content, and the like. Note that all pieces of content are content for which the copy control information compatible with the MMT format is recorded.

The first information processing device (DTCP source) 60 includes a broadcast receiver (STB) 61, a TV 62, a recording and reproducing device 63, a PC 64, and a portable terminal 65. These are merely examples, and various devices can be used in addition to the above devices. The first information processing device (DTCP source) 60 executes, for example, processing of reproducing received content, processing of recording data to a medium such as an HDD, a BD, or a flash memory.

The first information processing device (DTCP source) 60 is capable of understanding the MMT format data and performing the processing of the MMT format data.

The first information processing device (DTCP source) 60 executes processing according to the copy control information compatible with the MMT format.

Moreover, when transmitting the received content from the transmission device 50 to the second information processing device (DTCP sink) 70, the first information processing device (DTCP source) 60 converts the copy control information compatible with the MMT format into the copy control information defined by DTCP and transmits the converted copy control information.

The copy control information defined by DTCP2 is generated as converted data and transmitted in association with the content in the case where the transmitted content is high-image quality content such as 4K content, 8K content, or HDR content, and the copy control information defined by DTCP1 is generated as converted data and transmitted in association with the content in the case where the transmitted content is 2K content and is SDR content.

The second information processing device (DTCP sink) 70 includes a TV 71, a recording and reproducing device 72, a PC 73, and a portable terminal 74. These are merely examples, and various devices can be used in addition to the above devices. The second information processing device (DTCP sink) 70 executes processing of reproducing content received from the first information processing device (DTCP source), and processing of recording data to a medium such as an HDD, a BD, or a flash memory, for example.

Moreover, the second information processing device (DTCP sink) 70 executes, for example, processing of outputting content to an unillustrated third information processing device.

When using received content (DTCP content) received from the first information processing device (DTCP source) 60, the second information processing device (DTCP sink) 70 executes processing according to the copy control information recorded according to the DTCP rule.

The copy control information is data obtained by the first information processing device (DTCP source) 60 converting the copy control information into the copy control information defined by DTCP on the basis of the copy control information defined by ARIB compatible with the MMT format. Therefore, the second information processing device (DTCP sink) 70 can perform copy control taking over the copy control information defined by ARIB compatible with the MMT format.

[3. MPEG Media Transport (MMT) Format]

As described with reference to FIG. 3, data transmission from the transmission device 50 such as a broadcasting station is executed according to the MPEG media transport (MMT) format.

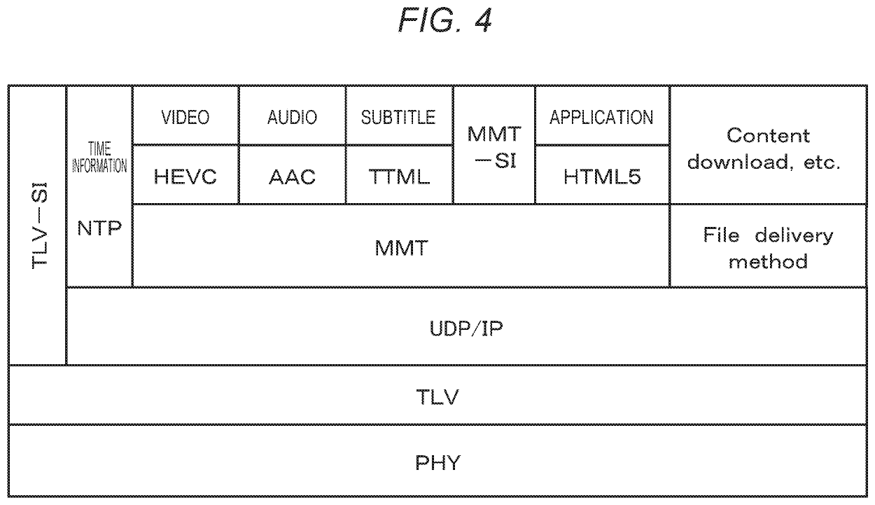

The MPEG media transport (MMT) format will be described with reference to FIG. 4 and the subsequent drawings.

FIG. 4 is a diagram illustrating a stack model of the MMT format.

In the MMT stack model illustrated in FIG. 4, the lowest layer is a physical layer (PHY). The physical layer is divided into a broadcast (broadcasting) layer for performing broadcast-based processing and a broadband layer for performing network-based processing.

MMT enables processing using two communication networks, which are the broadcast-based and network-based communication networks.

As an upper layer of the physical layer (PHY), there is a type length value (TLV) layer. TLV is a format rule layer that defines a method of multiplexing IP packets. A plurality of IP packets is multiplexed and transmitted as a TLV packet. TLV-SI is a transmission layer of control information (SI) such as a control message according to a TLV format.

The control information (signaling information (SI))

includes setting information necessary for receiving and reproducing content (program) on the reception device side, guide information such as a program guide, notification information, control information, and management information.

The control information (SI) stored in the TLV packet processed and generated in the TLV layer is TLV-SI and mainly includes control information regarding reception processing.

The control information (SI) stored in an MMTP packet, which is a packet generated according to an MMT protocol (MMTP), is MMT-SI illustrated in the uppermost layer and mainly includes control information regarding reproduction control.

An UDP/IP layer is set on the TLV layer.

Specifically, the UDP/IP layer can be divided into an IP layer and an UDP layer, and is a layer that defines transmission for storing an UDP packet in a payload of an IP packet.

An MMT layer and a file delivery method layer are set on the UDP/IP layer.

Both of a case of storing an MMTP packet in an IP packet and transmitting the packets, and a method of transmitting data as an IP packet using the file delivery method that is a data transmission method without using an MMTP packet are available.

The following layers are set on the MMT layer.

Each of the following data are stored in an MMTP packet and transmitted:

video data that is coded video data according to high efficiency video coding (HEVC) as a video coding standard;

audio data that is coded audio data according to advanced audio coding (AAC) as an audio coding standard;

subtitle data that is coded subtitle data according to timed text markup language (TTML) as a subtitle coding standard;

control information (MMT-SI) transmitted using the MMTP packet; and

moreover, various applications described according to hyper text markup language 5 (HTML5).

The control information (MMT-SI) is control information (signaling information) transmitted with the MMTP packet, and includes setting information necessary for receiving and reproducing content (program) on the information processing device 30 side, guide information such as a program guide, notification information, control information, management information, and the like.

Note that time information (network time protocol (NTP)) is absolute time information and is directly stored in the UDP packet and transmitted.

A data service for distributing other data, content download, etc. can be distributed using a file delivery method different from MMT.

As illustrated in FIG. 4, the control information (MMT-SI) and applications including videos, audios, subtitles, and further, the various types of management information such as the notification information and the control information are transmitted using the MMTP packet.

[4. Copy Control Information Set in MMT Format Data]

Next, copy control information set in the MMT format data distributed by the transmission device such as a broadcasting station will be described.

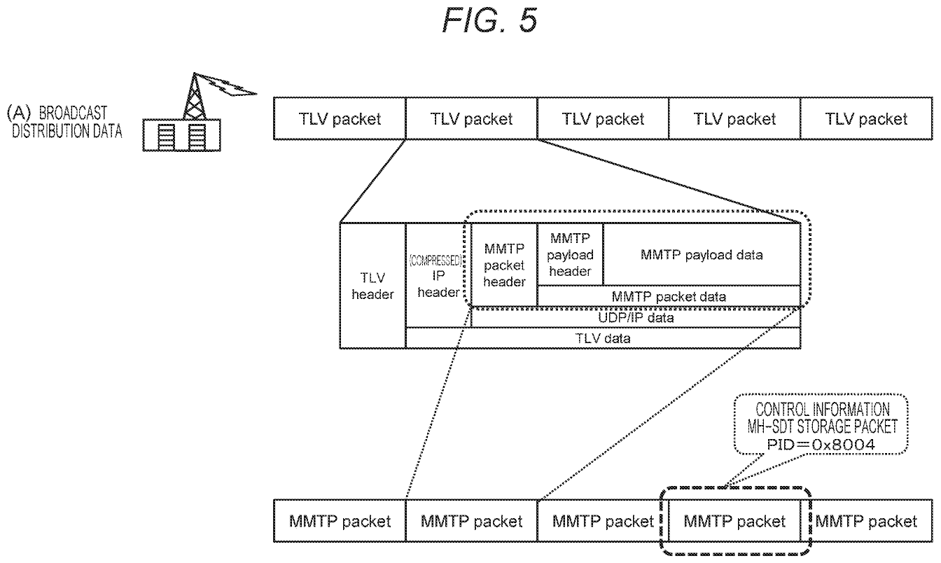

The program content and the copy control information according to the MMT format transmitted by a broadcasting station or the like will be described with reference to FIG. 5 and the subsequent drawings.

FIG. 5 illustrates a TLV packet string according to the MMT format transmitted by the transmission device such as a broadcasting station, the configuration of the TLV packet, and an MMTP packet string in which the MMTP packets included in each of the TLV packets are extracted and arranged.

Each MMTP packet included in the MMTP packet string is configured as a packet that stores videos, audios, or subtitles, reproduction object data, the control information (signaling information (SI)), and the like in units of data type.

What kind of data is stored in each MMTP packet can be identified by a packet ID (PID) recorded in a header of the MMTP packet.

For example, the copy control information is recorded in a service description table (MH-SDT) that is a control information recording table defined in the MMT format.

Note that the MMT format has various control information recording tables according to the types of recorded control data. Specifically, for example, there are the following tables:

(a) TLV-NIT (network information table);

(b) MH-BIT (broadcaster information table);

(c) MH-SDT (service description table);

(d) MH-EIT (event information table);

(e) MH-TOT (time offset table); and

(f) MPT (MMT package table).

The service description table (MH-SDT) is one of the control information recording tables, and is a table in which channel-related information such as channel names, broadcaster names, and the like is recorded.

The copy control information is recorded in this service description table (MH-SDT).

As illustrated in FIG. 5, in the MMTP packet storing the service description table (MH-SDT),

PID=0x8004

is recorded as the packet ID (PID).

A device on a user side extracts the service description table (MH-SDT) from a setting packet with the PID=0x8004 and acquires the copy control information from description data.

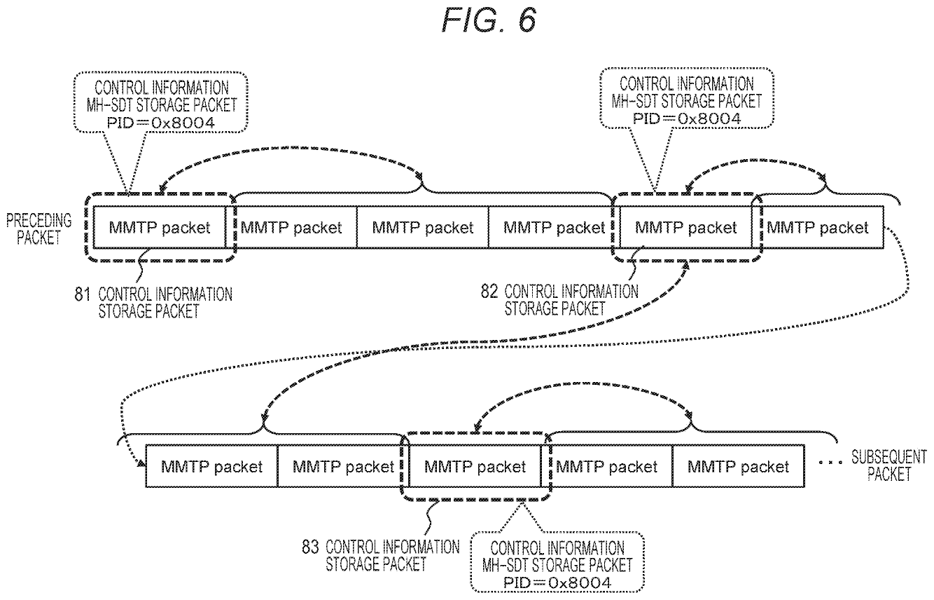

Note that, as illustrated in FIG. 6, the MMTP packet storing the service description table (MH-SDT) is transmitted at intervals of several seconds, and the copy control information stored in one packet storing MH-SDT is applied to the content stored in a subsequent packet storing the reproduction object data.

For example, a control information storage packet 81 storing the service description table (MH-SDT) illustrated in FIG. 6 is used as the copy control information regarding the content such as videos, audios, and subtitles stored in a subsequent MMTP within a period to a next control information storage packet 82.

The control information storage packet 82 is used as the copy control information regarding the content stored in a subsequent MMTP within the period to a next control information storage packet 83.

In this way, the copy control information regarding the content stored in the MMTP can be confirmed by referring to the service description table (MH-SDT) stored in the control information storage packet.

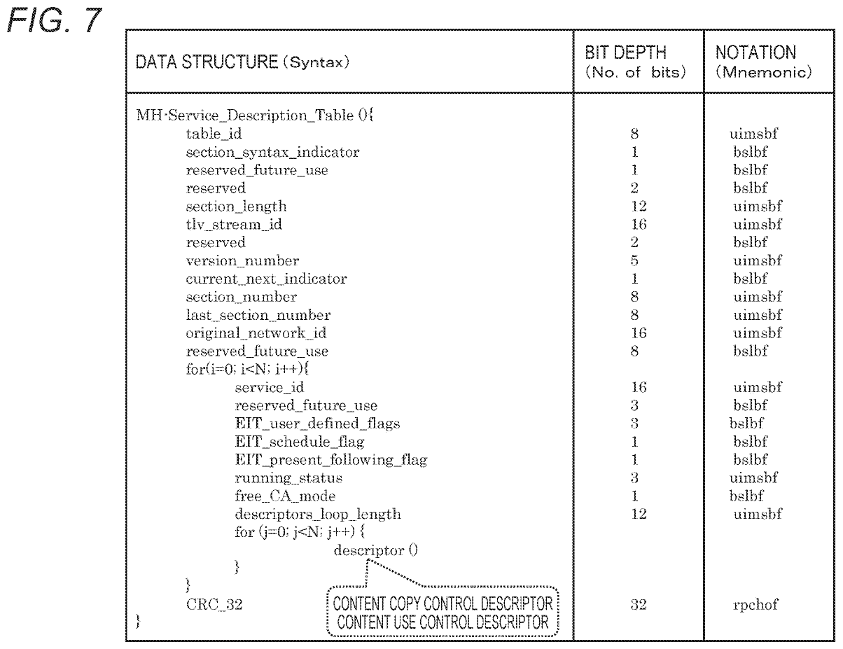

Next, a specific data configuration of the service description table (MH-SDT) will be described with reference to FIG. 7 and the subsequent drawings.

FIG. 7 is a diagram illustrating a data configuration (syntax) of the service description table (MH-SDT) stored in the MMTP packet.

Note that a bit depth (No. of bits) and data notation (Mnemonic) are illustrated together with the data configuration (Syntax).

Note that “uimsbf” in the data notation means “unsigned integer most significant bit first” notation.

“bslbf” means “bit string, left bit first”.

Note that the control information regarding the MMT format data is recorded in a plurality of tables according to the type (category) of the control information.

As described above, for example, there are the following tables:

(a) TLV-NIT (network information table);

(b) MH-BIT (broadcaster information table);

(c) MH-SDT (service description table);

(d) MH-EIT (event information table);

(e) MH-TOT (time offset table); and

(f) MPT (MMT package table).

Moreover, in these tables, each pieces of subordinately classified control information included in a specific category are recorded in units of descriptor.

In a descriptor (descriptor) recording area of the service description table (MH-SDT) illustrated in FIG. 7, the following descriptors are recorded:

(1) content copy control descriptor; and

(2) content use control descriptor.

Note that these data can be recorded for each predetermined content section such as a program unit and the like.

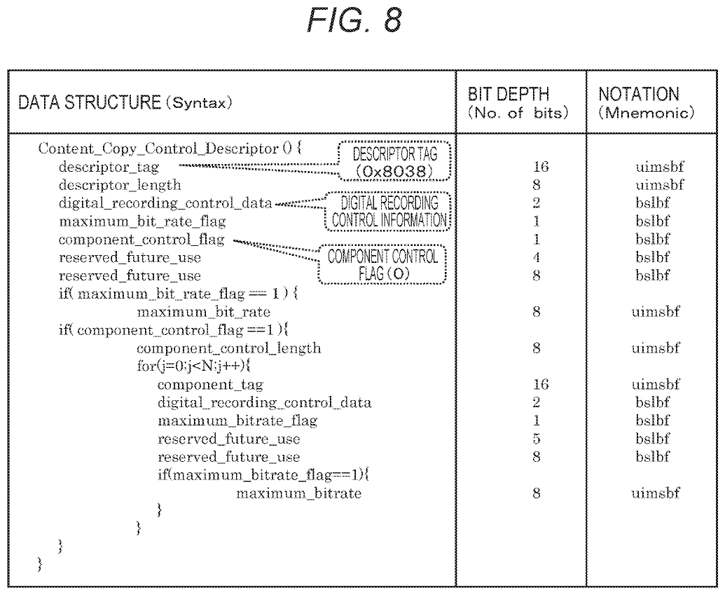

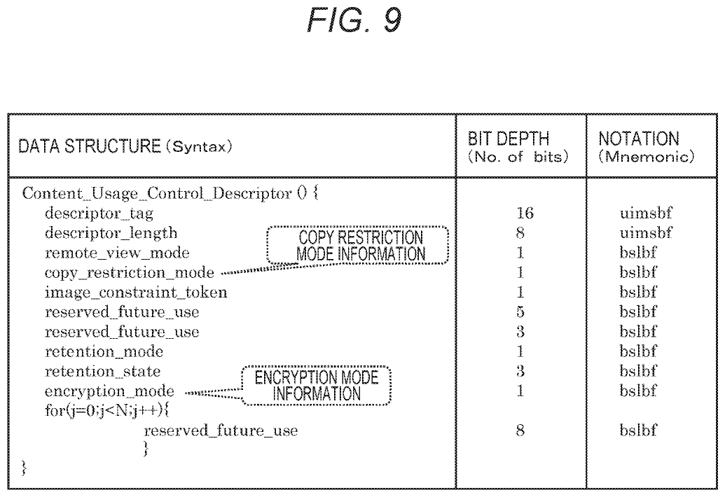

Specific data configurations of the above two descriptors will be described with reference to FIGS. 8 and 9.

First, the data configuration (Syntax) of “(1) content copy control descriptor” will be described with reference to FIG. 8.

In the content copy control descriptor illustrated in FIG. 8, for example, each of the following data is recorded as illustrated in FIG. 8:

a descriptor tag (descriptor_tag);

digital recording control information (digital_recording_control_data); and

a component control flag (component_control_flag).

In the descriptor tag (descriptor_tag),

an identification tag (0x8038) indicating that this descriptor is a content copy control descriptor is recorded.

In the digital recording control information (digital_recording_control_data),

a value indicating whether or not to execute copy processing as digital recording is recorded.

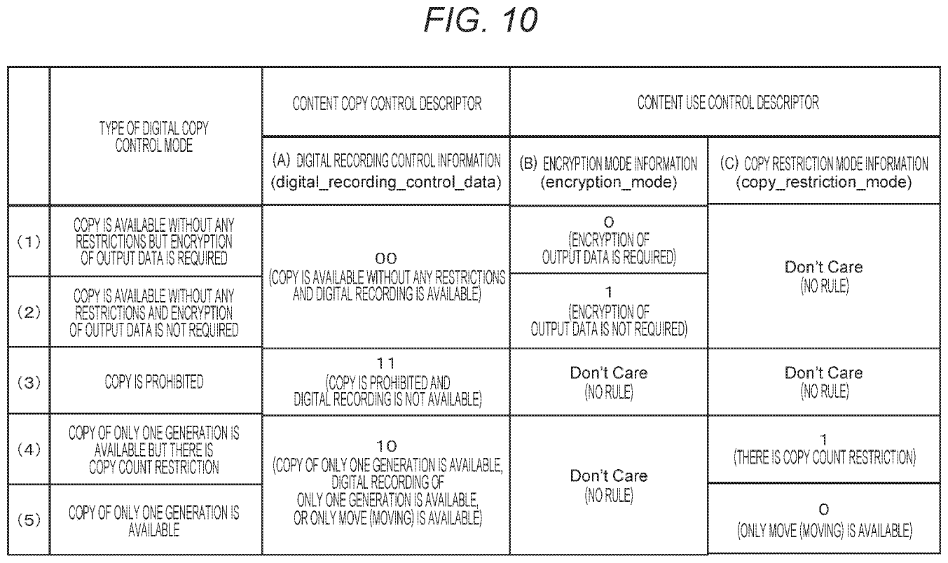

A specific example will be described later with reference to FIG. 10.

A value indicating whether or not this descriptor (content copy control descriptor) is valid is recorded in the component control flag (component_control_flag). For example, the following 1 bit is recorded:

valid=0; and

invalid=1.

Next, the data configuration (Syntax) of the “content use control descriptor” that is another descriptor recorded as the descriptor in the service description table (MH-SDT) illustrated in FIG. 7 will be described with reference to FIG. 9.

As illustrated in FIG. 9, in the “content use control descriptor”, each of the following data are recorded, for example:

copy restriction mode information (copy_restriction_mode); and

encryption mode information (encryption_mode).

In the copy restriction mode information (copy_restriction_mode),

data indicating whether or not there is a restriction on the copy count that is a copyable number is recorded.

For example, the following data are recorded:

restriction on copy count=1; and

no restriction on copy count=0.

In the encryption mode information (encryption_mode), data indicating whether or not output data in the case of performing the copy processing is required to be output as encrypted data is recorded.

For example, the following data are recorded:

encryption of output data is required=0; and

encryption of output data is not required=1.

In the service description table (MH-SDT) illustrated in FIG. 7, the following three types of copy control-related information are recorded, as described with reference to FIGS. 8 and 9:

(A) digital recording control information (digital_recording_control_data);

(B) encryption mode information (encryption_mode); and

(C) copy restriction mode information (copy_restriction_mode).

FIG. 10 illustrates a diagram summarizing a list of types (five types) of digital copy control modes and settings of three types of control information defined in the MMT format.

FIG. 10 illustrates the following five types of digital copy control modes:

(1) copy is available without any restrictions but encryption of output data is required;

(2) copy is available without any restrictions and encryption of output data is not required;

(3) copy is prohibited;

(4) copy of only one generation is available but there is copy count restriction; and

(5) copy of only one generation is available.

For the above five types of digital copy control modes, the settings of three types of control information defined in the MMT format are as follows, as illustrated in FIG. 10.

(1) Copy is available without any restrictions but encryption of output data is required

(A) Digital recording control information=00 (copy is available and digital recording is available without restrictions)

(B) Encryption mode information=0 (output data encryption required)

(C) Copy restriction mode information=Don't Care (no rule)

(2) Copy is available without any restrictions and encryption of output data is not required

(A) Digital recording control information=00 (copy is available and digital recording is available without restrictions)

(B) Encryption mode information=1 (encryption of output data is not required)

(C) Copy restriction mode information=Don't Care (no rule)

(3) Copy is prohibited

(A) Digital recording control information=11 (copy is prohibited and digital recording is unavailable)

(B) Encryption mode information=Don't Care (no rule)

(C) Copy restriction mode information=Don't Care (no rule)

(4) Copy of only one generation is available but there is copy count restriction

(A) Digital recording control information=10 (copy of only one generation is available, digital recording of only one generation is available, or only move is available)

(B) Encryption mode information=Don't Care (no rule)

(C) Copy restriction mode information=1 (with copy count restriction)

(5) Copy of only one generation is available

(A) Digital recording control information=10 (copy of only one generation is available, digital recording of only one generation is available, or only move is available)

(B) Encryption mode information=Don't Care (no rule)

(C) Copy restriction mode information=0 (only move is available)

For the five types of digital copy control modes (1) to (5) illustrated in FIG. 10, the three types of control information defined in the MMT format, that is, the following recorded data:

(A) digital recording control information (digital recording control data);

(B) encryption mode information (encryption_mode); and

(C) copy restriction mode information (copy restriction mode) are set as described above and in FIG. 10.

[5. Processing of Converting Copy Control Information Compatible with MMT Format into Copy Control Information by DTCP2]

Next, processing of converting copy control information compatible with the MMT format into copy control information by DTCP2 will be described.

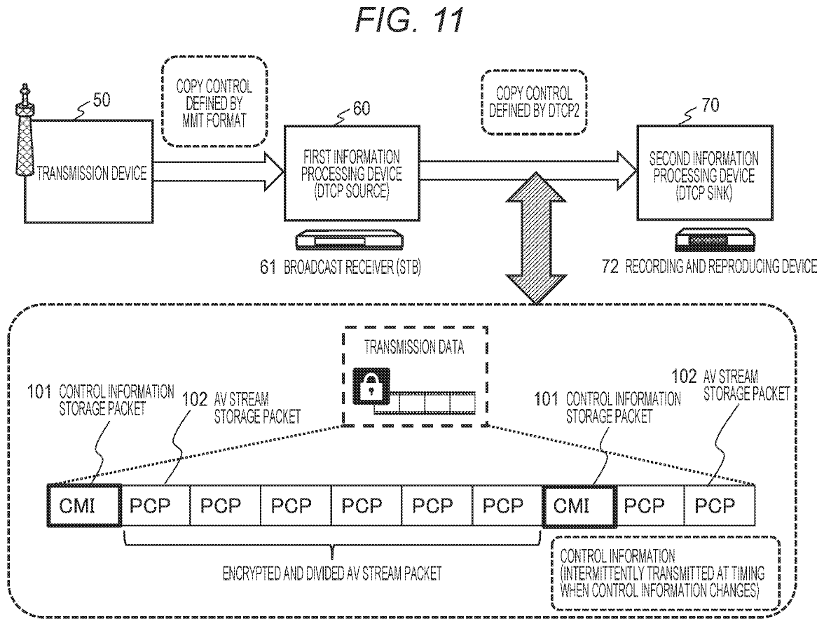

FIG. 11 illustrates the transmission device 50, the first information processing device (DTCP source) 60, and the second information processing device (DTCP sink) 70, similarly to the configuration described with reference to FIG. 3.

The broadcast receiver (STB) 61 is illustrated as an example of the first information processing device (DTCP source) 60, and the recording and reproducing device 72 is illustrated as an example of the second information processing device (DTCP sink) 70.

As described above, when transmitting the received content from the transmission device 50 to the second information processing device (DTCP sink) 70, the first information processing device (DTCP source) 60 converts the copy control information compatible with the MMT format into the copy control information defined by DTCP and transmits the converted copy control information. In a case where the transmitted content is high-image quality content such as 4K content, 8K content, or HDR content, the copy control information defined by DTCP2 is set and transmitted.

FIG. 11 illustrates, in a lower part, an example of a data format of transmission data from the first information processing device (DTCP source) 60 to the second information processing device (DTCP sink) 70.

As illustrated in FIG. 11, the transmission data includes the following two types of packets:

(a) control information storage packet (CMI) 101; and

(b) AV stream storage packet (PCP) 102.

In the control information storage packet (content management information (CMI)) 101, the control information such as the copy control information regarding the subsequent AV stream storage packet (protected content packet (PCP)) 102 is recorded.

Note that the AV stream storage packet (PCP) 102 is encrypted data.

The control information storage packet (CMI) 101 is intermittently transmitted in a form of being inserted in the AV stream storage packet (PCP) 102 string, for example, at timing when the control information changes and the like.

In a CMI descriptor (CMI Descriptor) of the control information storage packet (CMI) 101, content control information regarding the subsequent AV stream storage packet (PCP) 102 is recorded.

The control information storage packet (CMI) 101 can store one or more CMI descriptors and the content control information can be described by various representation methods.

The second information processing device (DTCP sink) 70 that receives the transmission data from the first information processing device (DTCP source) 60 can refer to any CMI descriptor of the control information storage packet (CMI) 101.

The first information processing device (DTCP source) 60 always stores one or more CMI descriptors in the control information storage packet (CMI) 101.

The control information storage packet (CMI) 101 is usually sent once before the AV stream storage packet (PCP) 102 storing content data. Note that, in a case where control content of the content changes in the middle of the content, the control information storage packet (CMI) 101 recording the new control content is transmitted at that position.

The control information storage packet (CMI) 101 is sent in plain text. If the packet is falsified, the second information processing device (DTCP sink) 70 cannot correctly generate an encryption key that is necessary for decrypting the encrypted content stored in the subsequent AV stream storage packet (PCP) 102. This is because the configuration data of the control information storage packet (CMI) 101 is used as encryption key generation information.

The second information processing device (DTCP sink) 70 that receives the transmission data from the first information processing device (DTCP source) 60 refers to only the control information storage packet (CMI) 101 as content control information. Since the second information processing device (DTCP sink) 70 does not refer to information in a content stream, a DTCP descriptor and the like are not defined. Furthermore, this operation does not depend on the format of the AV stream stored in the AV stream storage packet (PCP) 102.

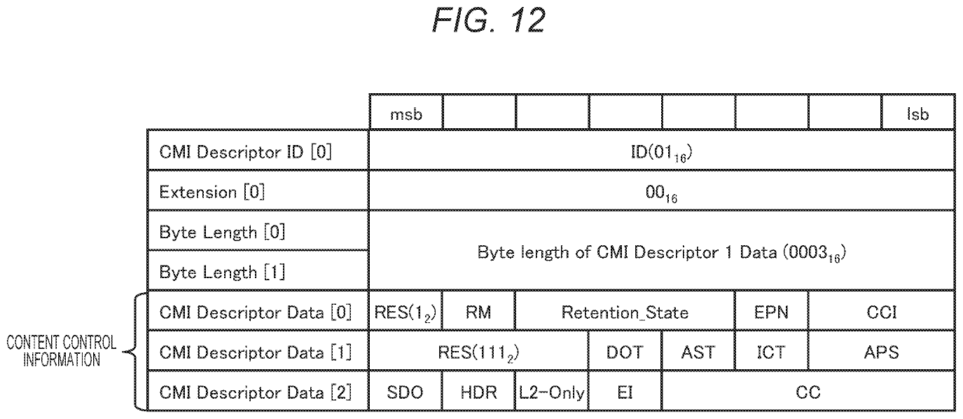

FIG. 12 is a diagram for describing a data configuration (Syntax) of the CMI descriptor (CMI Descriptor) stored in the control information storage packet (CMI) 101.

As illustrated in FIG. 12, the content control information including content copy control information is recorded in three-byte data recording area of CMI descriptor data [0] to [3] (CMI Descriptor Data [0] to [3]) of the CMI descriptor (CMI Descriptor) stored in the control information storage packet (CMI) 101.

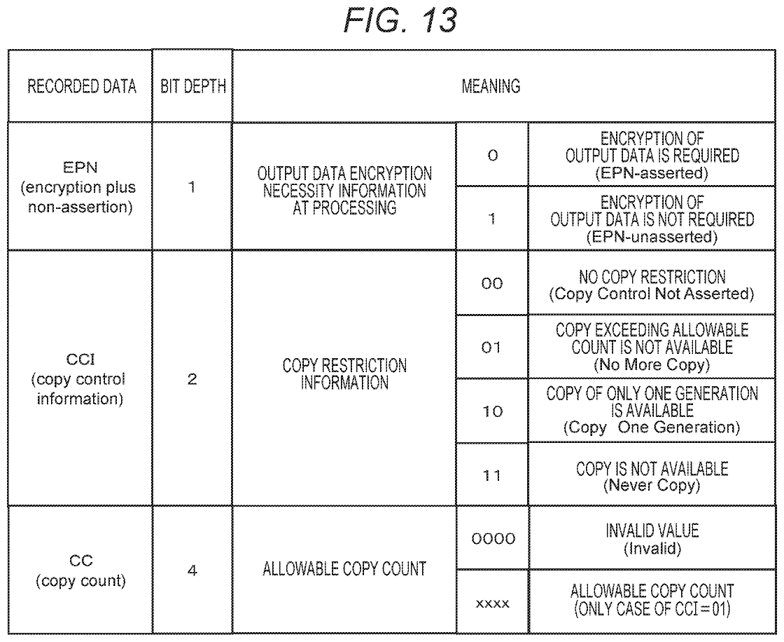

FIG. 13 illustrates main copy control information recorded in the content control information recording area.

The main copy control information recorded in the content control information recording area includes the following three types of information:

EPN=output data encryption necessity information;

CCI=copy restriction information; and

CC=allowable copy count.

Encryption plus non-asserted (EPN) is an area for recording information as to whether or not encryption is required when data is output (digitally output). Note that EPN is valid information only in a case where CCI described below is 00 (no copy restriction).

Copy control information (CCI) is an area for recording information as to whether or not copy processing is allowed.

Copy count (CC) is an area for recording information regarding the allowable copy count.

Details of the EPN, CCI, and CC will be described with reference to FIG. 13.

EPN is an area for recording the output data encryption necessity information, and

can record 1-bit data of 0 or 1.

The recording bit values 0 and 1 have the following meanings:

(1) the bit value: 0=encryption of output data (digital data) is required (EPN-asserted); and

(2) the bit value: 1=encryption of output data (digital data) is not required (EPN-unasserted).

CCI is an area for recording copy restriction information, and can record 2-bit data from 00 to 11.

The recording bit values 00 to 11 have the following meanings:

(1) the bit value: 00=no copy restriction (Copy Control Not Asserted);

(2) the bit value: 01=copy exceeding an allowable count (CC set value) is not available (No More Copy);

(3) the bit value: 10=copy of only one generation is available (Copy One Generation); and

(4) the bit value: 11=copy is not available (Never Copy).

CC is an area for recording the allowable copy count, and the allowable copy count (xxxx) can be recorded. Note that a value is set within a range of xxxx=0000 to 1111 (binary number).

Note that the allowable copy count (xxxx) is recorded only in a case where CCI=01 is set. In a case where CCI=00, 10, 11, CC=0000 is recorded and interpreted as an invalid value.

The main data of other content control information recorded in the three-byte data recording area of the CMI descriptor data [0] to [3] (CMI Descriptor Data [0] to [3]) illustrated in FIG. 12 are the following data.

RES: A reserve (Reserved) field in which a fixed value [1] is recorded. ([12]) indicates that a binary value 1 is stored.

Note that the set value of the reserve field is used as information for generating an encryption key to be applied for decrypting an encrypted AV stream stored in the AV stream storage packet (PCP) 102 following the control information storage packet (CMI) 101.

RM: A retention mode (Retention_mode) recording field. The retention mode is a content retention period setting mode. In the case where the mode is set to the retention mode (the set value=[0]), the content can be temporarily stored in a storage unit (medium).

Retention State: A retainable (content-retainable) period is recorded. For example, the following 3-bit data: 000 to 111 are recorded:

000=Permanently retainable;

001=1 week;

010=2 days;

011=1 day;

100=12 hours;

101=6 hours;

110=3 hours; and

111=90 minutes.

DOT: Digital output limitation information (Digital Only Token) is recorded. In a case of DOT=0, only digital data can be output as a video signal (=analog output prohibited)

AST: Analog outputtability information (Analog Sunset Token) is recorded. In a case of AST=0, analog output of a video signal is prohibited.

ICT: Outputtable image quality information (Image Constraint Token) at analog output is recorded. In a case of ICT=0, the image quality at analog output needs to be down-converted to SD image quality (equivalent to DVD image quality).

APS: Protection type information (Analog Protection System) of an analog video signal is recorded.

00=off, 01=type 1, 10=type 2, and 11=type 3 are represented.

SDO: Outputtable information (Standard Digital Output Token) of digital data is recorded. SDO=1 means that output of digital data is allowed in a case where DTCP1 or an output protection technology certified by DTCP1 is applied. This is also a technology certified in the compliance rules of DTCP2. Note that, even in the case of SDO=1, the data cannot be passed to a certified record protection technology.

The value of SDO is changed according to a data output mode of a data output device.

HDR: Processing definition information (high dynamic range token) of an HDR image. Content of HDR=1 is prohibited to be down-converted into SDR content. This is data for content in which an image is destroyed by SDR conversion.

In the case of setting HDR=1, it is necessary to make an SDR version of the same content available.

Note that an HDR value is set to a fixed value according to a distributor of received content, such as a broadcasting station.

L2-Only: Technical information (L2 protection Only Token) to be applied as a content protection technology is recorded. DTCP2 has two security levels: L2 protection (L2-protection), which is a highly secure content protection technology, and L1 protection (L1-protection), which is a content protection technology equivalent to DTCP1.

As a general rule, conventional 2K/SDR content can be handled by L1, and content exceeding the 2K/SDR needs to be handled by L2. Note that content of L2-Only=1 always needs to be handled by L2. Only services that do not allow content to be handled at any level below L1 can have a value of 1.

Note that an L2-Only value is set to a fixed value according to a distributor of received content, such as a broadcasting station.

EI: Content protection level information (Enhanced Image Token) according to the image quality. EI=1 is set in a case where content quality exceeds 2K/SDR, indicating that L2-level protection is required.

The value of EI is changed according to a data output mode of a data output device.

As described with reference to FIGS. 12 and 13, the content control information predetermined by DTCP2 has a similar configuration to the copy control information compatible with the MMT format described with reference to FIG. 10 but the configurations are not the same.

As described above with reference to FIG. 11, when transmitting the received content from the transmission device 50 to the second information processing device (DTCP sink) 70, the first information processing device (DTCP source) 60 converts the copy control information compatible with the MMT format into the copy control information defined by DTCP and transmits the converted copy control information. In a case where the transmitted content is high-image quality content such as 4K content, 8K content, or HDR content, the copy control information defined by DTCP2 is set and transmitted.

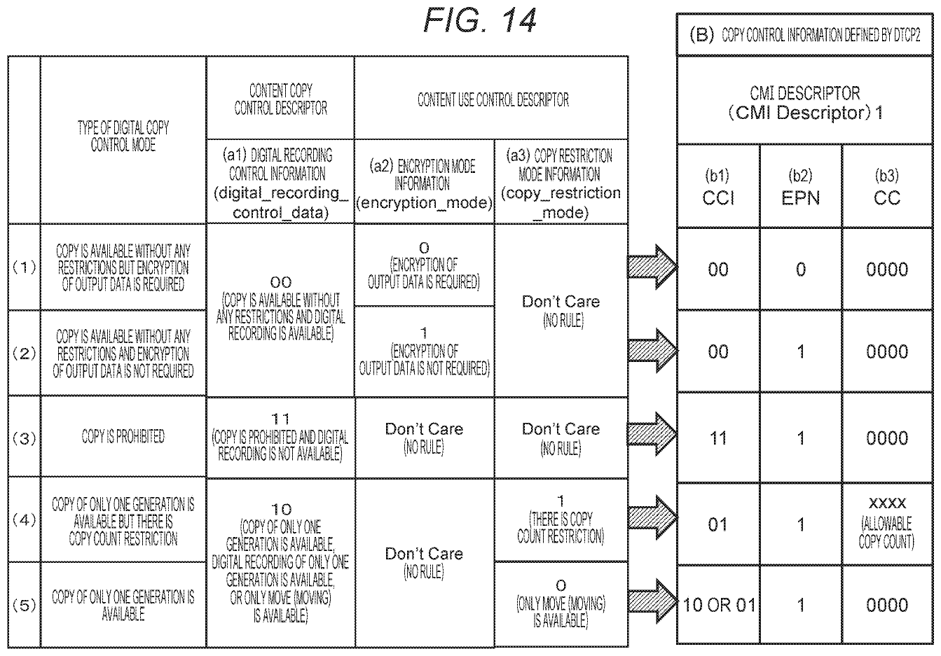

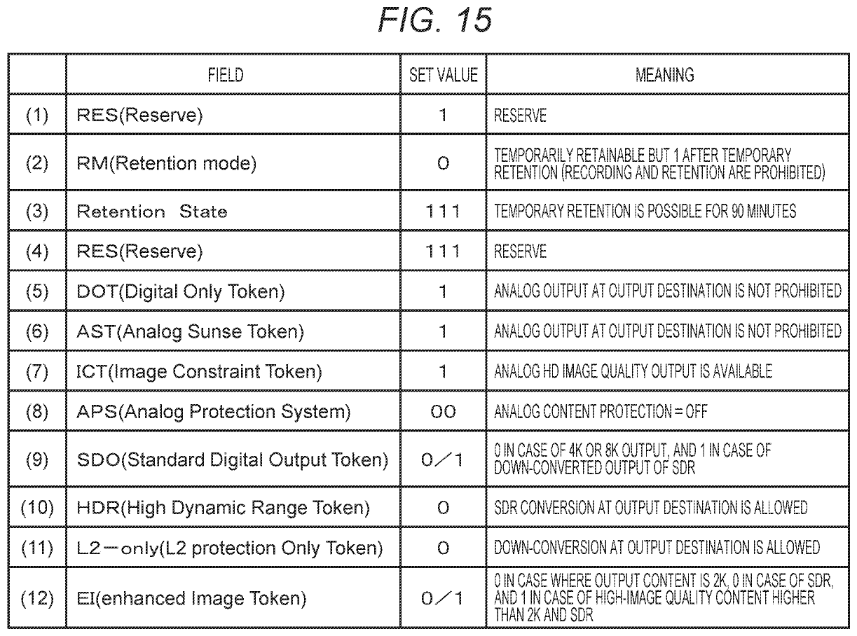

Hereinafter, processing of converting the copy control information compatible with the MMT format into the copy control information defined by DTCP2 executed by the first information processing device (DTCP source) 60, that is, control information mapping processing will be described with reference to FIGS. 14 and 15.

FIG. 14 is a diagram illustrating conversion rules (mapping rules) in the case of converting the copy control information compatible with the MMT format described above with reference to FIG. 10 into the copy control information defined by DTCP2.

The first information processing device (DTCP source) 60 converts the copy control information compatible with the MMT format recorded in association with the received content from the transmission device 50 into the copy control information defined by DTCP2 according to the mapping rules, and transmits the converted copy control information together with the content to the second information processing device (DTCP sink) 70.

The conversion rules (mapping rules) illustrated in FIG. 14 will be described.

FIG. 14 illustrates the following five types of digital copy control modes:

(1) copy is available without any restrictions but encryption of output data is required;

(2) copy is available without any restrictions and encryption of output data is not required;

(3) copy is prohibited;

(4) copy of only one generation is available but there is copy count restriction; and

(5) copy of only one generation is available.

FIG. 14 illustrates set values of two different pieces of copy control information:

(A) copy control information compatible with the MMT format (ARIB: TR-B39); and

(B) copy control information defined by DTCP2 (CMI descriptor),

for each of the above-described five types of digital copy control modes.

Note that the copy control information compatible with the MMT format (ARIB: TR-B39) includes each of the following information:

(a1) digital recording control information (digital recording control data);

(a2) encryption mode information (encryption_mode); and

(a3) copy restriction mode information (copy restriction mode).

Furthermore, the copy control information defined by DTCP2 (CMI descriptor) includes each of the following information:

(b1) copy restriction information (CCI);

(b2) output data encryption necessity information (EPN); and

(b3) allowable copy count (CC).

The first information processing device (DTCP source) 60 first acquires each of the set values of (A) copy control information compatible with the MMT format (ARIB: TR-B39) illustrated in FIG. 14 recorded in association with the received content from the transmission device 50. That is, the set value of each of the following information is acquired:

(a1) digital recording control information (digital recording control data);

(a2) encryption mode information (encryption_mode); and

(a3) copy restriction mode information (copy restriction mode).

Next, which of the entries (1) to (5) of the mapping rules illustrated in FIG. 14 the combination of the set values corresponds is selected, and the set values of (B) copy control information defined by DTCP2 on the right side, that is, the set values of:

(b1) copy restriction information (CCI);

(b2) output data encryption necessity information (EPN); and

(b3) allowable copy count (CC)

are acquired according to the arrow associated with the selected entry.

Moreover, the first information processing device (DTCP source) 60 records the acquired copy control information defined by DTCP2 in the CMI descriptor (CMI Descriptor) described with reference to FIG. 12 and generates the control information storage packet (CMI) 101, and transmits the control information storage packet (CMI) 101 together with the content to the second information processing device (DTCP sink) 70.

The processing (mapping processing) of converting the copy control information into the copy control information defined by the DTCP2 executed by the first information processing device (DTCP source) 60 in each case where the set value of the copy control information (ARIB:TR-B39) compatible with the MMT format recorded in association with the received content from the transmission device 50 is one of the entries (1) to (5) of the mapping rules illustrated in FIG. 14 will be hereinafter sequentially described.

(1) Copy is available without any restrictions but encryption of output data is required

Each of the set values of (A) copy control information compatible with the MMT format (ARIB: TR-B39) in this case is as follows:

(a1) digital recording control information=00 (copy is available and digital recording is available without restrictions);

(a2) encryption mode information=0 (output data encryption required); and

(a3) copy restriction mode information=Don't Care (no rule).

In this case, the first information processing device (DTCP source) 60 sets the following set values for the copy control information defined by DTCP2:

(b1) copy restriction information (CCI)=00 (no copy restriction);

(b2) output data encryption necessity information (EPN)=0 (output data encryption is required); and

(b3) allowable copy count (CC)=0000 (invalid value).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

(2) copy is available without any restrictions and encryption of output data is not required;

Each of the set values of (A) copy control information compatible with the MMT format (ARIB: TR-B39) in this case is as follows:

(a1) digital recording control information=00 (copy is available and digital recording is available without restrictions);

(a2) Encryption mode information=1 (encryption of output data is not required); and

(a3) copy restriction mode information=Don't Care (no rule).

In this case, the first information processing device (DTCP source) 60 sets the following set values for the copy control information defined by DTCP2:

(b1) copy restriction information (CCI)=00 (no copy restriction);

(b2) Output data encryption necessity information (EPN)=1 (encryption of output data is not required); and

(b3) allowable copy count (CC)=0000 (invalid value).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

(3) copy is prohibited; Each of the set values of (A) copy control information compatible with the MMT format (ARIB: TR-B39) in this case is as follows:

(a1) digital recording control information=11 (copy is prohibited and digital recording is unavailable);

(a2) encryption mode information=Don't Care (no rule); and

(a3) copy restriction mode information=Don't Care (no rule).

In this case, the first information processing device (DTCP source) 60 sets the following set values for the copy control information defined by DTCP2:

(b1) copy restriction information (CCI)=11 (copy is not available);

(b2) output data encryption necessity information (EPN)=1; and

(b3) allowable copy count (CC)=0000 (invalid value).

Note that the EPN setting is valid only in the case where CCI=00, and EPN=1 simply sets a default value in the case where CCI is a value other than 00, which does not mean that encryption of output data is not required. This also applies to the subsequent cases where CCI is a value other than 00.

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

(4) copy of only one generation is available but there is copy count restriction; and

Each of the set values of (A) copy control information compatible with the MMT format (ARIB: TR-B39) in this case is as follows:

(a1) digital recording control information=10 (copy of only one generation is available and digital recording of only one generation is available);

(a2) encryption mode information=Don't Care (no rule); and

(a3) copy restriction mode information=1 (with copy count restriction).

In this case, the first information processing device (DTCP source) 60 sets the following set values for the copy control information defined by DTCP2:

(b1) copy restriction information (CCI)=01 (copy exceeding an allowable count is not available);

(b2) output data encryption necessity information (EPN)=1; and

(b3) allowable copy count (CC)=xxxx (allowable copy count).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

Note that, in the present processing example, for (b3) allowable copy count (CC)=xxxx (allowable copy count), a value acquired from the control information of the received content such as the broadcast content received by the first information processing device (DTCP source) 60 is recorded. Alternatively, a value defined in advance, for example, an allowable copy count 10=(1010) or the like is set.

Furthermore, in a case where the first information processing device (DTCP source) 60 itself creates and records a copy of the received content to a recording medium such as an HDD, a value obtained by subtracting 1 from (b3) allowable copy count (CC)=xxxx (allowable copy count) is recorded and transmitted together with the content to the second information processing device (DTCP sink) 70.

(5) copy of only one generation is available.

Each of the set values of (A) copy control information compatible with the MMT format (ARIB: TR-B39) in this case is as follows:

(a1) digital recording control information=10 (copy of only one generation is available, digital recording of only one generation is available, or only move is available);

(a2) encryption mode information=Don't Care (no rule); and

(a3) copy restriction mode information=0 (only move is available).

In this case, the first information processing device (DTCP source) 60 sets the following set values for the copy control information defined by DTCP2:

(b1) copy restriction information (CCI)=10 (copy of only one generation is available);

(b2) output data encryption necessity information (EPN)=1; and

(b3) allowable copy count (CC)=0000 (invalid value). The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

Note that, in the present processing example, in the case where the first information processing device (DTCP source) 60 itself creates and records a copy of the received content to a recording medium such as an HDD,

the value of (b1) copy restriction information (CCI)=10 (copy of only one generation is available) is changed to the set value of (b1) copy restriction information (CCI)=01 (copy exceeding an allowable count is not available), and is transmitted together with the content to the second information processing device (DTCP sink) 70.

Furthermore, (CC) indicating the allowable copy count is set to 0000, which is a setting in which further copy is not allowed.

As described above, the first information processing device (DTCP source) 60 that receives the MMT format data such as the broadcast content from the transmission device 50 converts the copy control information compatible with the MMT format recorded in association with the received content into copy control information defined by DTCP2 according to the conversion rules (mapping rules) illustrated in FIG. 14, and transmits the converted copy control information together with the content to the second information processing device (DTCP sink) 70.

By performing the processing, the second information processing device (DTCP sink) 70 that has received the content from the first information processing device (DTCP source) 60 becomes able to perform copy control according to the copy control information defined by DTCP2.

As a result, copy control taking over the copy control information compatible with the MMT format associated with broadcast content becomes possible.

Note that, as described above with reference to FIG. 12, the CMI descriptor (CMI Descriptor) stored in the control information storage packet (CMI) 101 transmitted from the first information processing device (DTCP source) 60 to the second information processing device (DTCP sink) 70 has various control information recording fields for the copy control information (CCI, EPN, and CC) described with reference to FIG. 14.

The first information processing device (DTCP source) 60 performs the processing of setting the appropriate value for each of these fields on the basis of the received content and the control information thereof from the transmission device 50, and transmits the appropriate values together with the content to the second information processing device (DTCP sink) 70.

Content control information data recording examples for the data recording fields for information other than the copy control information (CCI, EPN, and CC) of the CMI descriptor (CMI Descriptor) will be described with reference to FIG. 15.

(1) RES: A reserve (Reserved) field, and [1] is recorded.

(2) RM: A retention mode (Retention_mode) recording field, and [0] is recorded. RM indicates that content can be temporarily recorded in a storage unit (medium). Note that [1] is recorded in the case where content has been recorded before data output.

(3) Retention State: [111]=90 minutes is recorded as a retainable (content-retainable) period.

(4) RES: A reserve (Reserved) field, and [111] is recorded.

(5) DOT: A recording field for digital output limitation information (Digital Only Token), and [1] is recorded. DOT indicates that analog video output is not prohibited at the data output destination.

(6) AST: A recording field for analog outputtability information (Analog Sunset Token), and [1] is recorded. AST indicates that analog video output is not prohibited at the data output destination.

(7) ICT: A recording field for outputtable image quality information (Image Constraint Token), and [1] is recorded. ICT indicates that analog HD image quality output is available.

(8) APS: A recording field for protection type information (Analog Protection System) of analog content, and [00] is recorded. APS indicates that the settings are off.

(9) SDO: A recording field for outputtable information (Standard Digital Output Token) of digital data, and in a case of outputting a 4K or 8K image [0], [1] is recorded in a case of down-converting the image into a 2K or SDR image and outputting the down-converted image.

(10) HDR: A recording field for processing definition information (high dynamic range token) of an HDR image, and [0] is recorded. HDR indicates that conversion into an SDR image at the output destination is allowed.

(11) L2-Only: A recording field for technical information (L2 protection Only Token) to be applied as a content protection technology, and [0] is recorded. L2-Only indicates that down-conversion at the output destination is allowed.

(12) EI: A recording field for content protection level information (Enhanced Image Token) according to the image quality, and [0] is recorded in the case of outputting a 2K or SDR image, and [1] is recorded in the case of outputting high-image quality content other than a 2K or SDR image.

The first information processing device (DTCP source) 60 sets the value to each of the fields of the CMI descriptor and generates the control information storage packet (CMI) 101, as illustrated in FIG. 15, for example, and transmits the control information storage packet (CMI) 101 together with content to the second information processing device (DTCP sink) 70.

The second information processing device (DTCP sink) 70 that has received the content from the first information processing device (DTCP source) 60 becomes able to control the content according to the content control information recorded in the CMI descriptor (CMI Descriptor) defined by DTCP2.

Note that the content control information setting examples described with reference to FIG. 15 are examples. The first information processing device (DTCP source) 60 can generate content control information in which an optimum control value is set according to attributes of content received from the transmission device 350, attributes of content to be transmitted to the second information processing device (DTCP sink) 70, and the like, and transmit the content control information to the second information processing device (DTCP sink) 70.

[6. Processing of Converting Copy Control Information Compatible with MMT Format into Copy Control Information of DTCP1]

Next, processing of converting copy control information compatible with the MMT format into copy control information of DTCP1 will be described.

As described above, when transmitting the received content from the transmission device 50 to the second information processing device (DTCP sink) 70, the first information processing device (DTCP source) 60 converts the copy control information compatible with the MMT format into the copy control information defined by DTCP and transmits the converted copy control information.

In this case, in the case where the transmitted content is high-image quality content such as 4K content, 8K content, or HDR content, the copy control information defined by DTCP2 described above with reference to FIGS. 11 to 15 is set and transmitted, whereas in the case where the transmitted content is 2K content and is further SDR content, the copy control information defined by DTCP1 needs to be generated as converted data and transmitted in association with the content.

Hereinafter, processing in the case where the transmitted content transmitted from the first information processing device (DTCP source) 60 to the second information processing device (DTCP sink) 70 is 2K content or SDR content, that is, processing of generating, by the first information processing device (DTCP source) 60, the copy control information defined by DTCP1 and transmitting the copy control information in association with the content to the second information processing device (DTCP sink) 70 will be described.

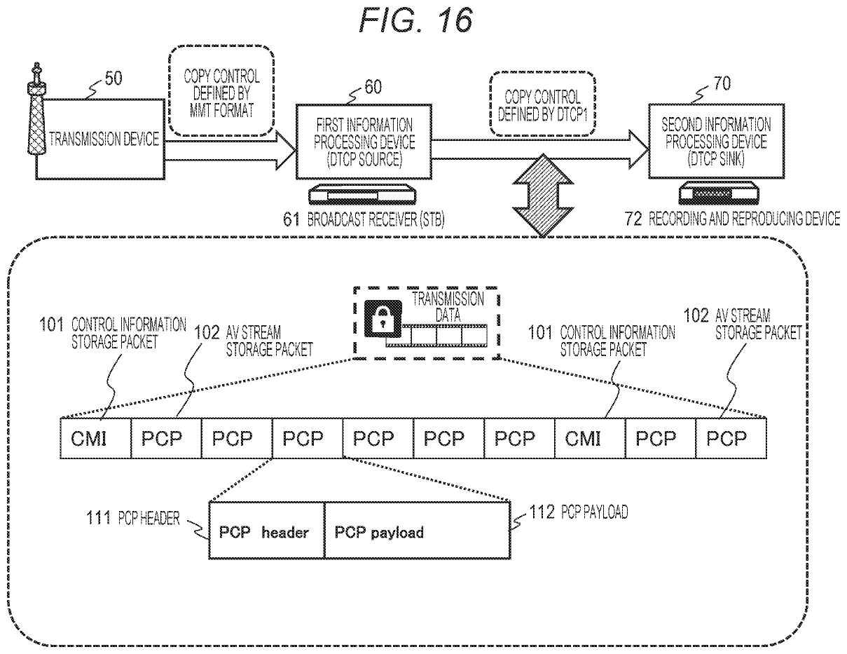

FIG. 16 illustrates the transmission device 50, the first information processing device (DTCP source) 60, and the second information processing device (DTCP sink) 70, similarly to the configuration described above with reference to FIG. 11.

The broadcast receiver (STB) 61 is illustrated as an example of the first information processing device (DTCP source) 60, and the recording and reproducing device 72 is illustrated as an example of the second information processing device (DTCP sink) 70.

The example illustrated in FIG. 16 is a processing example in the case where the first information processing device (DTCP source) 60 transmits normal-type content such as 2K content or SDR content, which is not high-image quality-type content such as 4K, 8K, or HDR, to the second information processing device (DTCP sink) 70.

This processing is executed in, for example, a case where the second information processing device (DTCP sink) 70 cannot process the high-image quality content such as 4K, 8K, or HDR, or in a case of reducing communication data.

The first information processing device (DTCP source) 60 down-converts the high-image quality content such as 4K, 8K, or HDR received from the transmission device 50 into normal content such as 2K content or SDR content, and transmits the normal content to the second information processing device (DTCP sink) 70.

Note that, in the case where the received content from the transmission device 50 is normal content such as 2K content or SDR content, the first information processing device (DTCP source) 60 transmits the received content to the second information processing device (DTCP sink) 70 without performing down-conversion.

As described above, in the case where the transmitted content is high-image quality content such as 4K content, 8K content, or HDR content, the copy control information defined by DTCP2 described above with reference to FIGS. 11 to 15 is set and transmitted, whereas in the case where the transmitted content is 2K content and is SDR content, the copy control information defined by DTCP1 needs to be generated as converted data and transmitted in association with the content.

FIG. 16 illustrates, in a lower part, an example of a data format of the transmission data from the first information processing device (DTCP source) 60 to the second information processing device (DTCP sink) 70. As illustrated in FIG. 16, the transmission data includes the following two types of packets:

(a) control information storage packet (CMI) 101; and

(b) AV stream storage packet (PCP) 102.

These packet configurations are similar to the configurations described above with reference to FIG. 11. Note that, in the case of DTCP1, CMI is not necessarily used. Hereinafter, an example of not using the widely implemented CMI will be described.

In the case of not using CMI, the content control information including the copy control information defined by DTCP1 is recorded in a different position from the content control information defined by DTCP2.

The content control information including the copy control information defined by DTCP1 is recorded in at least one of a PCP header 111 or a PCP payload 112 configuring the AV stream storage packet (PCP) 102 illustrated in FIG. 16.

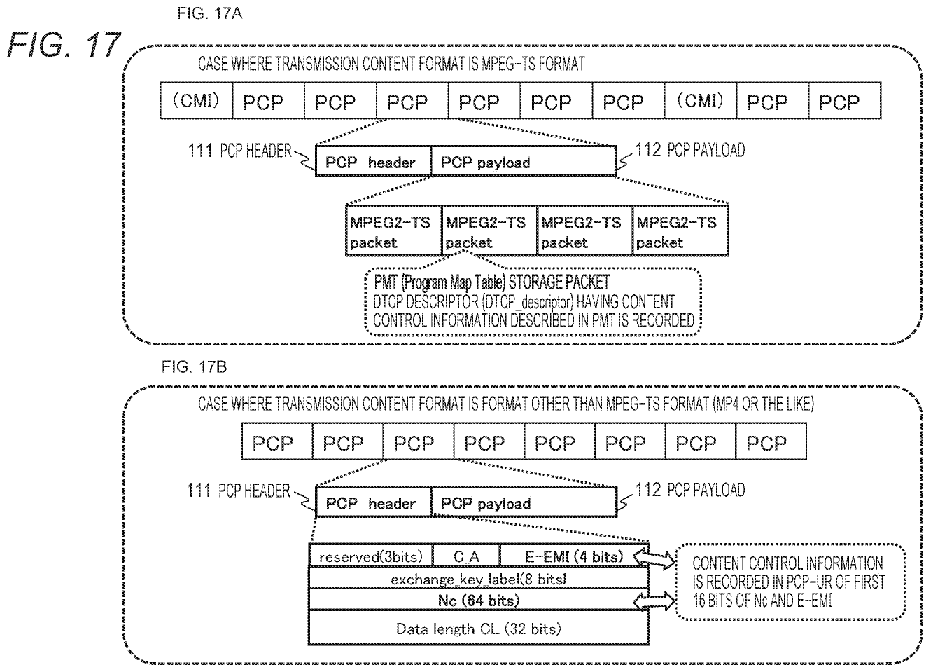

The content control information recording area is different depending on the format of output content of the first information processing device (DTCP source) 60. A specific example will be described with reference to FIG. 17.

As illustrated in FIG. 17(A), in the case where the format for the transmission data from the first information processing device (DTCP source) 60 to the second information processing device (DTCP sink) 70 is an MPEG-TS format such as MPEG2-TS, the content control information is recorded in a program map table (PMT) stored in the PCP payload 112.

Meanwhile, as illustrated in FIG. 17(B), in the case where the format for the transmission data from the first information processing device (DTCP source) 60 to the second information processing device (DTCP sink) 70 is a format other than the MPEG-TS format such as MPEG2-TS, for example, a format such as MP4 or PS, the content control information is recorded in the PCP header 111.

4-bit copy control information is recorded in an extended encryption mode indicator (E-EMI) set in the PCP header 111. Moreover, various other pieces of content control information are recorded in the first 16-bit PCP-UR data recording area of an Nc data recording area for recording content key update information and the like.

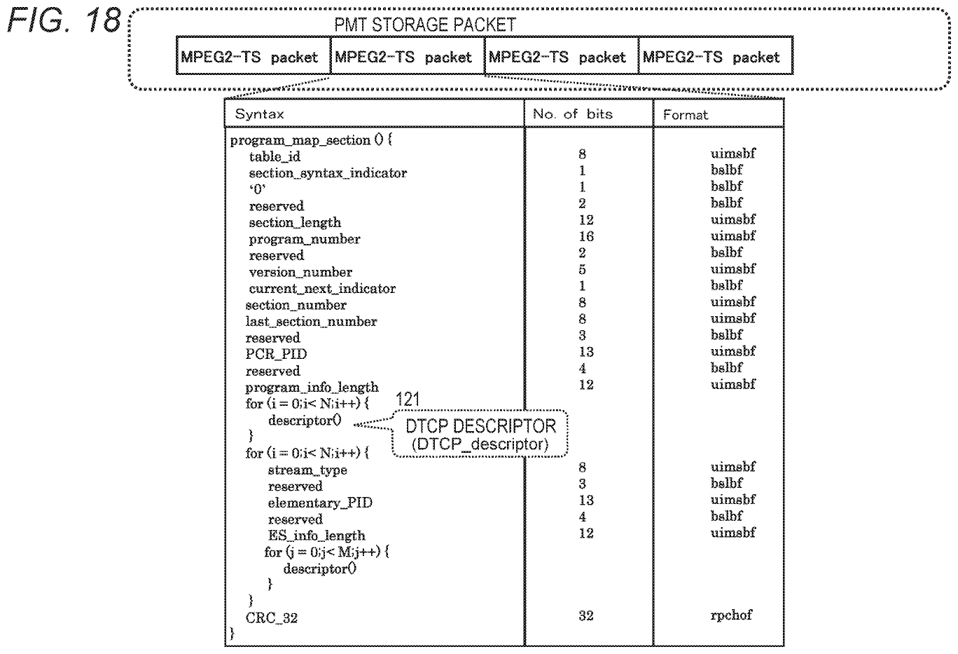

First, a specific copy control information recording example in the case where the format for the transmission data from the first information processing device (DTCP source) 60 to the second information processing device (DTCP sink) 70 is the MPEG-TS format such as MPEG2-TS will be described with reference to FIG. 18 and the subsequent drawings.

FIG. 18 is a diagram illustrating a data configuration (Syntax) of the program map table (PMT) stored in the PCP payload 112. Note that a bit depth (No. of bits) and data notation (Format) are illustrated together with the data configuration (Syntax). “uimsbf” in the data notation means “unsigned integer most significant bit first” notation.

“bslbf” means “bit string, left bit first”.

The program map table (PMT) illustrated in FIG. 18 is stored in the PCP payload 112 as described with reference to FIG. 17(A).

As illustrated in FIG. 18, a DTCP descriptor (DTCP_descriptor) 121 is recorded as one of the descriptors (descriptor) of the program map table (PMT).

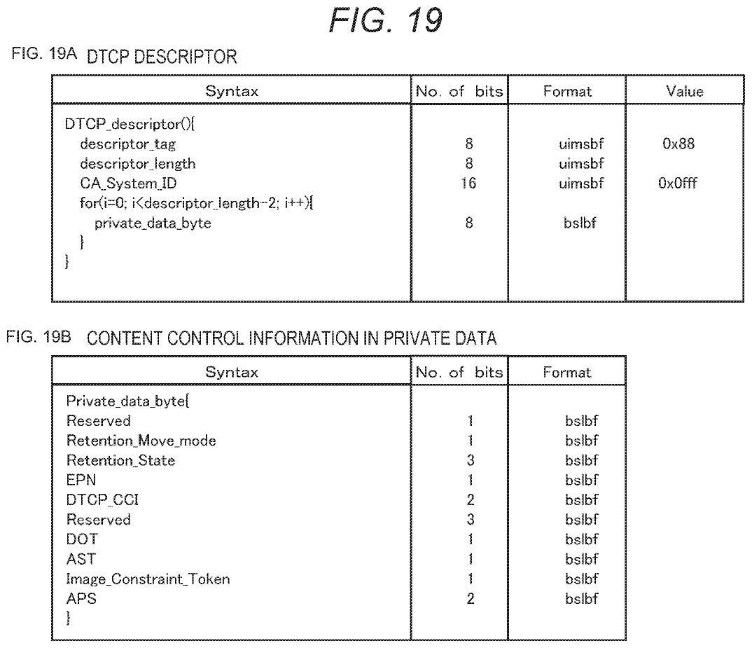

FIG. 19(A) is a diagram illustrating a data configuration (Syntax) of the DTCP descriptor (DTCP_descriptor) 121.

The DTCP descriptor (DTCP_descriptor) 121 includes each of the following data:

descriptor tag (descriptor_tag)=a descriptor identifier;

descriptor length (descriptor_length)=the number of descriptor bytes;

CA system ID (CA_System_ID)=an identifier indicating an application target; and

private data byte (private_data_byte)=a private data recording area.

In each of the above-described data, the private data byte (private_data_byte)=a private data recording area is an area in which recording of various data is allowed.

The first information processing device (DTCP source) 60 records, in the private data recording area, data taking over the control information in the MMT format data received by the broadcast wave or the like, such as the copy control information recorded in the service description table (MH-SDT), that is, the following information:

the content copy control descriptor; and

the content use control descriptor,

described with reference to FIGS. 7 to 10.

A data configuration example of the private data recording area is illustrated in FIG. 19(B).

The following data is recorded in the private data recording area, as illustrated in FIG. 19(B):

retention move mode (Retention_Move_Mode);

retention state (Retention_State);

EPN=output data encryption necessity information (encryption plus non-asserted);

DTCP-CCI=copy restriction information (copy control information);

DOT=digital output limitation information (Digital Only Token);

AST=analog outputtability information (Analog Sunset Token) at data output destination;

Image Constraint Token=outputtable image quality information (ICT) at analog output; and

APS=protection type information of analog content (Analog Protection System).

Note that these data can be recorded for each predetermined content section such as a program unit and the like.

Each of these pieces of information is information similar to the content control information compatible with DTCP2 described above with reference to FIG. 12.

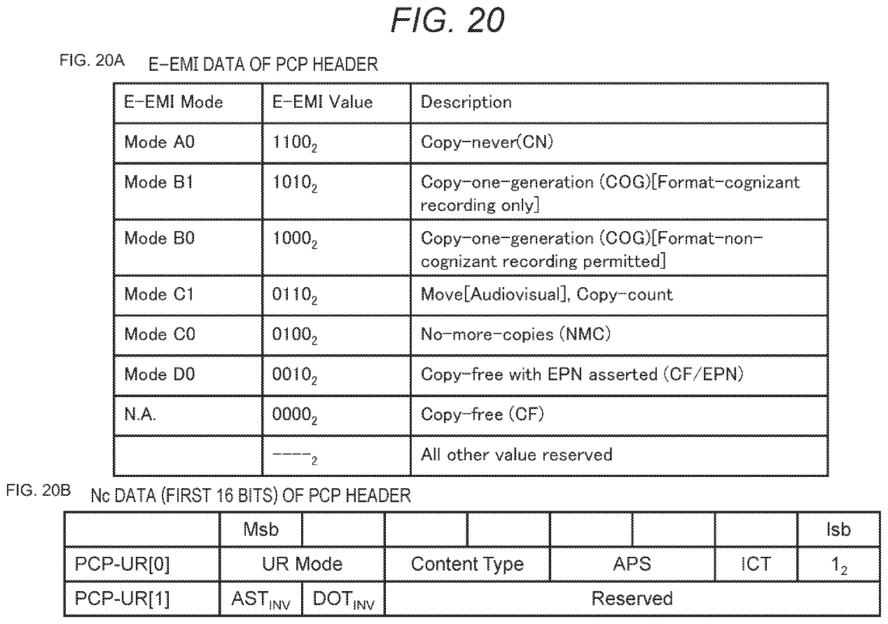

Next, a specific copy control information recording example in the case where the format for the transmission data from the first information processing device (DTCP source) 60 to the second information processing device (DTCP sink) 70 is a format other than the MPEG-TS format such as MPEG2-TS, for example, a format such as MP4 or PS will be described with reference to FIG. 20.

As described above with reference to FIG. 17(B), in the case where the format for the transmission data from the first information processing device (DTCP source) 60 to the second information processing device (DTCP sink) 70 is a format other than the MPEG-TS format such as MPEG2-TS, for example, a format such as MP4 or PS, the content control information is recorded in the PCP header 111.

4-bit copy control information is recorded in an extended encryption mode indicator (E-EMI) set in the PCP header 111. Moreover, various other pieces of content control information are recorded in the first 16-bit PCP-UR data recording area of an Nc data recording area for recording content key update information and the like.

FIG. 20 illustrates each of the following data examples:

(A) E-EMI data of the PCP header; and

(B) Nc data (first 16 bits) of the PCP header.

As illustrated in FIG. 20(A), the 4-bit copy control information is recorded in the E-EMI data recording area of the PCP header. As illustrated in FIG. 20(A), the 4-bit data recorded in the E-EMI data area is the copy control information of the stored content of the PCP packet and indicates the following settings:

1100 (mode A0)=copy is prohibited (Copy-never (CN));

1010 (mode B1)=copy of only one generation is available (Copy-one-generation) [note that only by a data analysis recording method (cognizant recording)];

1000 (mode B0)=copy of only one generation is available (COG: Copy-one-generation) [the method is not limited to the data analysis recording method (cognizant recording)];

0110 (mode C1)=move (Move) is available and copy count (copy-count);

0100 (mode C0)=copy exceeding an allowable count is not available (No-more-copy (NMC));

0010 (mode D0)=copy is available without restriction conditions but encryption of output data is required (Copy-free with EPN asserted (CF/EPN)); and

0000 (N.A.)=copy is available without restriction conditions (Copy-free (CF)).

FIG. 20(B) is a diagram illustrating a syntax (data configuration) of the Nc data (first 16 bits) of the PCP header. The following content control information is recorded in the PCP-UR data recording area of the Nc data (first 16 bits) of the PCP header.

APS=protection type information (Analog Protection System) of analog content

ICT=outputtable image quality information at analog output (Image Constraint Token)

AST=analog outputtability information (Analog Sunset Token) at data output destination

DOT=digital output limitation information (Digital Only Token)

Each of these pieces of information is information similar to the content control information compatible with DTCP2 described above with reference to FIG. 12.

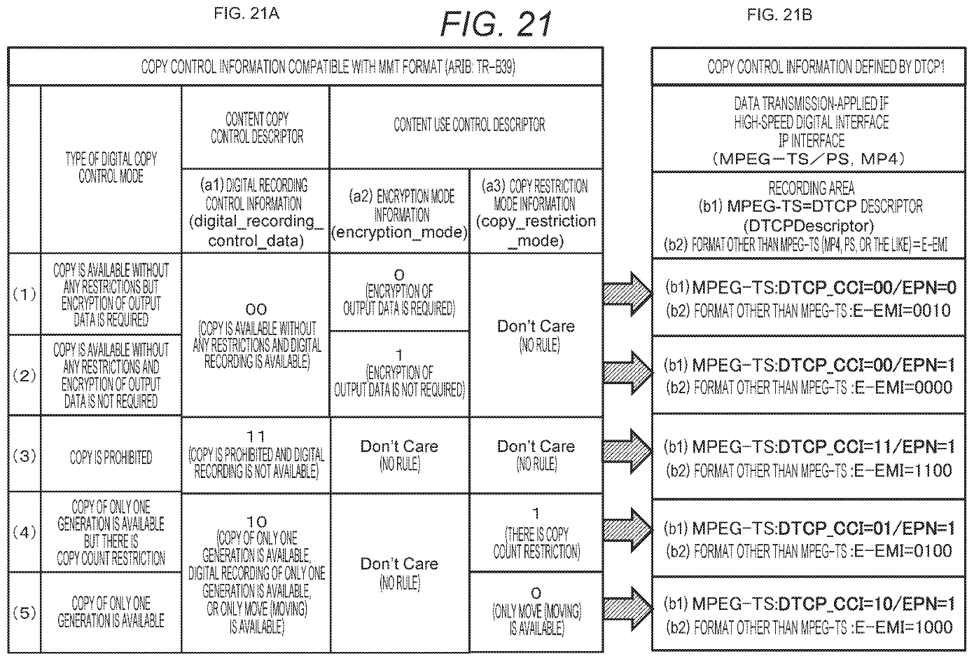

Next, processing of converting the copy control information compatible with the MMT format into the copy control information defined by DTCP1 executed by the first information processing device (DTCP source) 60, that is, control information mapping processing will be described with reference to FIG. 21 and the subsequent drawings.

FIG. 21 is a diagram illustrating conversion rules (mapping rules) in the case of converting the copy control information compatible with the MMT format described with reference to FIG. 10 into the copy control information defined by DTCP1.

The first information processing device (DTCP source) 60 converts the copy control information compatible with the MMT format recorded in association with the received content from the transmission device 50 into copy control information defined by DTCP1 according to the mapping rules, and transmits the converted copy control information together with the content to the second information processing device (DTCP sink) 70.

The conversion rules (mapping rules) illustrated in FIG. 21 will be described.

FIG. 21 illustrates the following five types of digital copy control modes:

(1) copy is available without any restrictions but encryption of output data is required;

(2) Copy is available without any restrictions and encryption of output data is not required

(3) Copy is prohibited

(4) Copy of only one generation is available but there is copy count restriction

(5) Copy of only one generation is available

FIG. 21 illustrates set values of two different pieces of copy control information:

(A) copy control information compatible with the MMT format (ARIB: TR-B39); and

(B) copy control information defined by DTCP1,

for each of the above-described five types of digital copy control modes.

Note that the recording area of (B) copy control information defined by DTCP1 is different depending on the format of the transfer data, as described with reference to FIGS. 17 to 19. That is,

in the case where the transfer data format is MPEG-TS (including MPEG2-TS), the copy control information defined by DTCP1 is recorded in the DTCP descriptor of the program map table (PMT) of the PCP header.

Furthermore, in the case where the transfer data format is a format other than MPEG-TS (MP4, PS, or the like), the copy control information defined by DTCP1 is recorded using the 4-bit data of E-EMI of the PCP payload.

As illustrated in FIG. 21(A), the copy control information compatible with the MMT format (ARIB: TR-B39) includes each of the following information:

(a1) digital recording control information (digital recording control data);

(a2) encryption mode information (encryption_mode); and

(a3) copy restriction mode information (copy restriction mode).

The first information processing device (DTCP source) 60 first acquires each of the set values of (A) copy control information compatible with the MMT format (ARIB: TR-B39) illustrated in FIG. 21 recorded in association with the received content from the transmission device 50. That is,

the set value of each of the following information is acquired:

(a1) digital recording control information (digital recording control data);

(a2) encryption mode information (encryption_mode); and

(a3) copy restriction mode information (copy restriction mode).

Next, which of the entries (1) to (5) of the mapping rules illustrated in FIG. 21 the combination of the set values corresponds is selected, and the set values of (B) copy control information defined by DTCP1 on the right side according to the arrow associated with the selected entry are acquired.

Note that, in the case where the transfer data format is MPEG-TS (including MPEG2-TS),

(b1) the set values (CCI and EPN) of the DTCP descriptor of the program map table (PMT) of the PCP payload are acquired.

Furthermore, in the case where the transfer data format is a format other than MPEG-TS (such as MP4 or PS),

(b2) the set value of the 4-bit data of the E-EMI of the PCP header is acquired.

Moreover, the first information processing device (DTCP source) 60 generates a PCP packet in which the acquired copy control information defined by DTCP1 is recorded, and transmits the PCP packet together with the content to the second information processing device (DTCP sink) 70.

The processing (mapping processing) of converting the copy control information into the copy control information defined by the DTCP1 executed by the first information processing device (DTCP source) 60 in each case where the set value of the copy control information (ARIB:TR-B39) compatible with the MMT format recorded in association with the received content from the transmission device 50 is one of the entries (1) to (5) of the mapping rules illustrated in FIG. 21 will be hereinafter sequentially described.

(1) copy is available without any restrictions but encryption of output data is required

Each of the set values of (A) copy control information compatible with the MMT format (ARIB: TR-B39) in this case is as follows:

(a1) digital recording control information=00 (copy is available and digital recording is available without restrictions);

(a2) encryption mode information=0 (output data encryption required); and

(a3) copy restriction mode information=Don't Care (no rule).

In this case, the first information processing device (DTCP source) 60 sets the following set values for the copy control information defined by DTCP1.

(b1) In the case of the transfer data format=MPEG-TS (including MPEG2-TS), the set values (CCI and EPN) of the DTCP descriptor of the PMT are set as follows:

(b11) copy restriction information (CCI)=00 (no copy restriction); and

(b12) output data encryption necessity information (EPN)=(output data encryption is required).

(b2) In the case of the transfer data format=a format other than MPEG-TS (such as MP4 or PS), the set value of the 4-bit data of the E-EMI of the PCP header is set as follows:

E-EMI=0010 (copy is available without restriction conditions but encryption of output data is required (CF/EPN)).

The first information processing device (DTCP source) 60 generates a PCP packet in which the copy control information defined by DTCP1 having the above-described set values is recorded, and transmits the PCP packet together with the content to the second information processing device (DTCP sink) 70.

(2) copy is available without any restrictions and encryption of output data is not required;

Each of the set values of (A) copy control information compatible with the MMT format (ARIB: TR-B39) in this case is as follows:

(a1) digital recording control information=00 (copy is available and digital recording is available without restrictions);

(a2) Encryption mode information=1 (encryption of output data is not required); and

(a3) copy restriction mode information=Don't Care (no rule).

In this case, the first information processing device (DTCP source) 60 sets the following set values for the copy control information defined by DTCP1.

(b1) In the case of the transfer data format=MPEG-TS (including MPEG2-TS), the set values (CCI and EPN) of the DTCP descriptor of the PMT are set as follows:

(b11) copy restriction information (CCI)=00 (no copy restriction); and

(b12) output data encryption necessity information (EPN)=(encryption of output data is not required).

(b2) In the case of the transfer data format=a format other than MPEG-TS (such as MP4 or PS), the set value of the 4-bit data of the E-EMI of the PCP header is set as follows:

E-EMI=0000 (=copy is available without restriction conditions (Copy-free (CF)).

The first information processing device (DTCP source) 60 generates a PCP packet in which the copy control information defined by DTCP1 having the above-described set values is recorded, and transmits the PCP packet together with the content to the second information processing device (DTCP sink) 70.

(3) copy is prohibited;

Each of the set values of (A) copy control information compatible with the MMT format (ARIB: TR-B39) in this case is as follows:

(a1) digital recording control information=11 (copy is prohibited and digital recording is unavailable);

(a2) encryption mode information=Don't Care (no rule); and

(a3) copy restriction mode information=Don't Care (no rule).

In this case, the first information processing device (DTCP source) 60 sets the following set values for the copy control information defined by DTCP1.

(b1) In the case of the transfer data format=MPEG-TS (including MPEG2-TS), the set values (CCI and EPN) of the DTCP descriptor of the PMT are set as follows:

(b11) copy restriction information (CCI)=11 (copy is not available); and

(b12) output data encryption necessity information (EPN)=1.

(b2) In the case of the transfer data format=a format other than MPEG-TS (such as MP4 or PS), the set value of the 4-bit data of the E-EMI of the PCP header is set as follows:

E-EMI=1100 (copy is prohibited (copy-never (CN)).

The first information processing device (DTCP source) 60 generates a PCP packet in which the copy control information defined by DTCP1 having the above-described set values is recorded, and transmits the PCP packet together with the content to the second information processing device (DTCP sink) 70.

(4) copy of only one generation is available but there is copy count restriction; and

Each of the set values of (A) copy control information compatible with the MMT format (ARIB: TR-B39) in this case is as follows:

(a1) digital recording control information=10 (copy of only one generation is available and digital recording of only one generation is available);

(a2) encryption mode information=Don't Care (no rule); and

(a3) copy restriction mode information=1 (with copy count restriction).

In this case, the first information processing device (DTCP source) 60 sets the following set values for the copy control information defined by DTCP1.

(b1) In the case of the transfer data format=MPEG-TS (including MPEG2-TS), the set values (CCI and EPN) of the DTCP descriptor of the PMT are set as follows:

(b11) copy restriction information (CCI)=01 (copy exceeding an allowable count is not available); and

(b12) output data encryption necessity information (EPN)=(b2) In the case of the transfer data format=a format other than MPEG-TS (such as MP4 or PS), the set value of the 4-bit data of the E-EMI of the PCP header is set as follows:

E-EMI=0100 (copy exceeding an allowable count is not available (No-more-copy (NMC)).

The first information processing device (DTCP source) 60 generates a PCP packet in which the copy control information defined by DTCP1 having the above-described set values is recorded, and transmits the PCP packet together with the content to the second information processing device (DTCP sink) 70.

Note that, as for the allowable copy count, a value acquired from the control information of the received content such as the broadcast content received by the first information processing device (DTCP source) 60 is separately recorded. Alternatively, a value defined in advance, for example, an allowable copy count 10=(1010) or the like is set.

Furthermore, in the case where the first information processing device (DTCP source) 60 itself creates and records a copy of the received content to a recording medium such as an HDD, a value obtained by subtracting 1 is recorded and transmitted together with the content to the second information processing device (DTCP sink) 70.

(5) Copy of only one generation is available Each of the set values of (A) copy control information compatible with the MMT format (ARIB: TR-B39) in this case is as follows:

(a1) digital recording control information=10 (copy of only one generation is available, digital recording of only one generation is available, or only move is available);

(a2) encryption mode information=Don't Care (no rule); and

(a3) copy restriction mode information=0 (only move is available).

In this case, the first information processing device (DTCP source) 60 sets the following set values for the copy control information defined by DTCP1.

(b1) In the case of the transfer data format=MPEG-TS (including MPEG2-TS), the set values (CCI and EPN) of the DTCP descriptor of the PMT are set as follows:

(b11) copy restriction information (CCI)=10 (copy of only one generation is available); and

(b12) output data encryption necessity information (EPN)=(b2) In the case of the transfer data format=a format other than MPEG-TS (such as MP4 or PS), the set value of the 4-bit data of the E-EMI of the PCP header is set as follows:

E-EMI=1000 (copy of only one generation is available (COG: Copy-one-generation) [the method is not limited to the data analysis recording method (cognizant recording)].

The first information processing device (DTCP source) 60 generates a PCP packet in which the copy control information defined by DTCP1 having the above-described set values is recorded, and transmits the PCP packet together with the content to the second information processing device (DTCP sink) 70.

Note that, in the present processing example, in the case where the first information processing device (DTCP source) 60 itself creates and records a copy of the received content to a recording medium such as an HDD,

the value of (b11) copy restriction information (CCI)=10 (copy of only one generation is available) is changed to the set value of copy prohibition of:

(b11) copy restriction information (CCI)=01 (copy exceeding an allowable count is not available), or

(b21) E-EMI=0100 (copy exceeding an allowable count is not available (No-more-copy (NMC)), and

is transmitted together with the content to the second information processing device (DTCP sink) 70.

As described above, the first information processing device (DTCP source) 60 that receives the MMT format data such as the broadcast content from the transmission device 50 converts the copy control information compatible with the MMT format recorded in association with the received content into copy control information defined by DTCP1 according to the conversion rules (mapping rules) illustrated in FIG. 21, and transmits the converted copy control information together with the content to the second information processing device (DTCP sink) 70.

By performing the processing, the second information processing device (DTCP sink) 70 that has received the content from the first information processing device (DTCP source) 60 becomes able to perform copy control according to the copy control information defined by DTCP1.

As a result, copy control taking over the copy control information compatible with the MMT format associated with broadcast content becomes possible.

Note that, as described above with reference to FIGS. 16 to 20,

the PMT stored in the payload of the PCP packet, or

the PCP header of the PCP packet

transmitted from the first information processing device (DTCP source) 60 to the second information processing device (DTCP sink) 70

has various control information recording fields in addition to the copy control information (CCI, EPN, and CC) described with reference to FIG. 21.

The first information processing device (DTCP source) 60 performs the processing of setting the appropriate value for each of these fields on the basis of the received content and the control information thereof from the transmission device 50, and transmits the appropriate values together with the content to the second information processing device (DTCP sink) 70.

As described above with reference to FIG. 17(A), in the case where the format for the transmission data from the first information processing device (DTCP source) 60 to the second information processing device (DTCP sink) 70 is an MPEG-TS format such as MPEG2-TS, the content control information is recorded in a program map table (PMT) stored in the PCP payload 112.

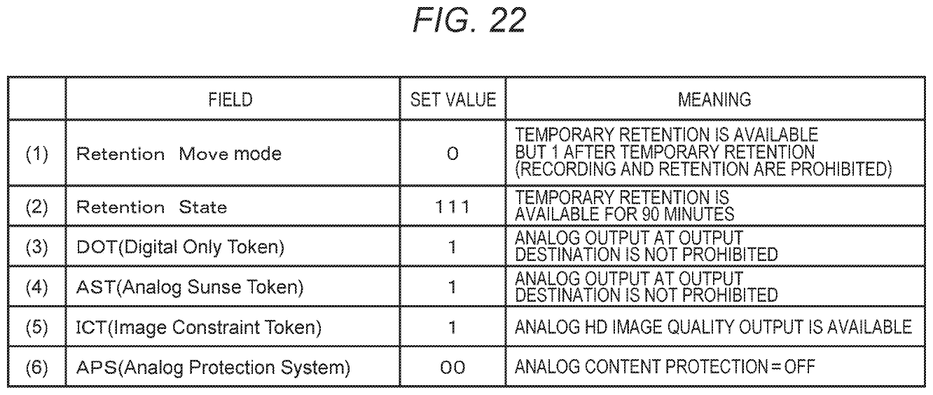

A recording example of the content control information to be recorded in the program map table (PMT) will be described with reference to FIG. 22.

(1) Retention Move mode: A retention move mode recording field, and [0] is recorded. RM indicates that content can be temporarily recorded in a storage unit (medium).

(2) Retention State: [111]=90 minutes is recorded as a retainable (content-retainable) period.

(3) DOT: A recording field for digital output limitation information (Digital Only Token), and [1] is recorded. AST indicates that analog video output is not prohibited at the data output destination.

(4) AST: A recording field for analog outputtability information (Analog Sunset Token), and [1] is recorded. AST indicates that analog video output is not prohibited at the data output destination.

(5) ICT: A recording field for outputtable image quality information (Image Constraint Token), and [1] is recorded. ICT indicates that analog HD image quality output is available.

(6) APS: A recording field for protection type information (Analog Protection System) of analog content, and [00] is recorded. APS indicates that the settings are off.

Next, in the case where the format for the transmission data to the second information processing device (DTCP sink) 70 is a format (MP4 or the like) other than the MPEG-TS format such as MPEG2-TS, the content control information is recorded in the PCP header 111.

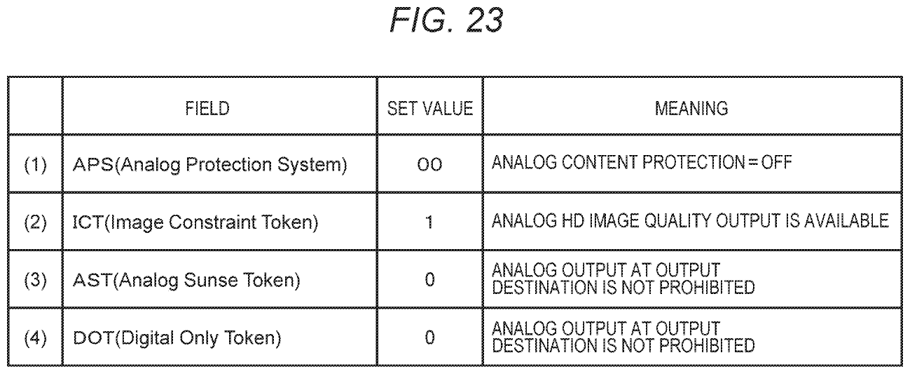

A recording example of the content control information to be recorded in the PCP header 111 will be described with reference to FIG. 23.

(1) APS: A recording field for protection type information (Analog Protection System) of analog content, and [00] is recorded. APS indicates that the settings are off.

(2) ICT: A recording field for outputtable image quality information (Image Constraint Token), and [1] is recorded. ICT indicates that analog HD image quality output is available.

(3) AST: A recording field for analog outputtability information (Analog Sunset Token) at copy destination, and [1] is recorded. AST indicates that analog video output is not prohibited at the copy destination.

(4) DOT: A recording field for digital output limitation information (Digital Only Token), and [1] is recorded. AST indicates that analog video output is not prohibited at the data output destination.

Note that it is also favorable to record each of the following set values of other content control information in a free area (reserve area or the like) of the PCP header 111.

(5) Retention Move mode: A retention move mode recording field, and [0] is recorded. RM indicates that content can be temporarily recorded in a storage unit (medium). Note that [1] is recorded in the case where content has been recorded before data output.

(6) Retention State: [111]=90 minutes is recorded as a retainable (content-retainable) period.

The first information processing device (DTCP source) 60 generates a PCP packet in which the content control information including the copy control information described with reference to FIGS. 21 to 23, for example, is recorded, and transmits the PCP packet together with the content to the second information processing device (DTCP sink) 70.

The second information processing device (DTCP sink) 70 that has received the content from the first information processing device (DTCP source) 60 acquires the content control information defined by DTCP1 from the PCP packet and becomes able to control the content according to the control information.

Note that the content control information setting examples described with reference to FIGS. 22 and 23 are examples. The first information processing device (DTCP source) 60 can generate content control information in which an optimum control value is set according to attributes of content received from the transmission device 350, attributes of content to be transmitted to the second information processing device (DTCP sink) 70, and the like, and transmit the content control information to the second information processing device (DTCP sink) 70.

[7. Conversion Processing and Transmission Example of Copy Control Information Corresponding to Specific Example of Data Transmission]

Next, conversion processing and a transmission example of the copy control information corresponding to specific examples of transmission of various data from the first information processing device (DTCP source) 60 to the second information processing device (DTCP sink) 70 will be described.

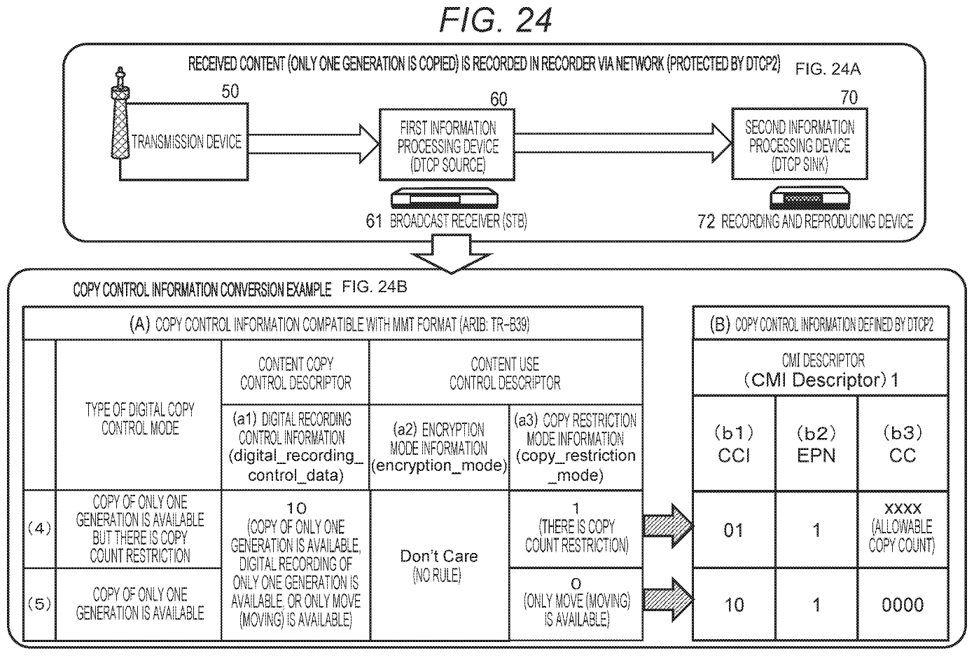

A plurality of specific examples will be sequentially described with reference to FIG. 24 and the subsequent drawings. Note that all of the processing examples described below are processing examples in which the first information processing device (DTCP source) 60 generates the copy control information compatible with DTCP2 and transmitting the copy control information together with content to the second information processing device (DTCP sink) 70. That is, the first information processing device (DTCP source) 60 executes the processing of converting the copy control information according to the conversion rules (mapping rules) described above with reference to FIG. 14.

### Processing Example 1

First, processing example 1 will be described with reference to FIG. 24.

(Processing Example 1) illustrated in FIG. 24 is a processing example in which the first information processing device (DTCP source) 60 receives content in which the copy control information compatible with the MMT format (ATIB TR-B39)=only one generation is copyable from the transmission device 50, converts the copy control information into the copy control information compatible with DTCP2, and transmits the converted copy control information to the second information processing device (DTCP sink) 70.

The first information processing device (DTCP source) 60 is, for example, the broadcast receiver (STB) 61, and the second information processing device (DTCP sink) 70 is, for example, the recording and reproducing device (recorder) 72.

FIG. 24(1b) illustrates the extracted entries (4) and (5) of the conversion rules (mapping rules) described above with reference to FIG. 14.

(4) Copy of only one generation is available but there is copy count restriction

(5) Copy of only one generation is available

In a case where the content received by the first information processing device (DTCP source) 60 from the transmission device 50 corresponds to the entry (4) of the conversion rules (mapping rules), that is,

(4) copy of only one generation is available but there is copy count restriction,

each of the set values of (A) copy control information compatible with the MMT format (ARIB: TR-B39) is as follows.

(a1) digital recording control information=10 (copy of only one generation is available and digital recording of only one generation is available);

(a2) encryption mode information=Don't Care (no rule); and

(a3) copy restriction mode information=1 (with copy count restriction).

In this case, the first information processing device (DTCP source) 60 sets the following set values for the copy control information defined by DTCP2:

(b1) copy restriction information (CCI)=01 (copy exceeding an allowable count is not available);

(b2) output data encryption necessity information (EPN)=1; and

(b3) allowable copy count (CC)=xxxx (allowable copy count).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

Furthermore, in a case where the content received by the first information processing device (DTCP source) 60 from the transmission device 50 corresponds to the entry (5) of the conversion rules (mapping rules), that is,

(5) copy of only one generation is available,

each of the set values of (A) copy control information compatible with the MMT format (ARIB: TR-B39) is as follows.

(a1) digital recording control information=10 (copy of only one generation is available, digital recording of only one generation is available, or only move is available);

(a2) encryption mode information=Don't Care (no rule); and

(a3) copy restriction mode information=0 (only move is available).

In this case, the first information processing device (DTCP source) 60 sets the following set values for the copy control information defined by DTCP2:

(b1) copy restriction information (CCI)=10 (copy of only one generation is available);

(b2) output data encryption necessity information (EPN)=1; and

(b3) allowable copy count (CC)=0000 (invalid value).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

Note that the settings of the entries (4) and (5) can be determined in advance according to the transmission source (broadcasting station) of the broadcast content, for example, other than by the processing determining the settings on the basis of the copy control information associated with the broadcast content.

### Processing Example 2

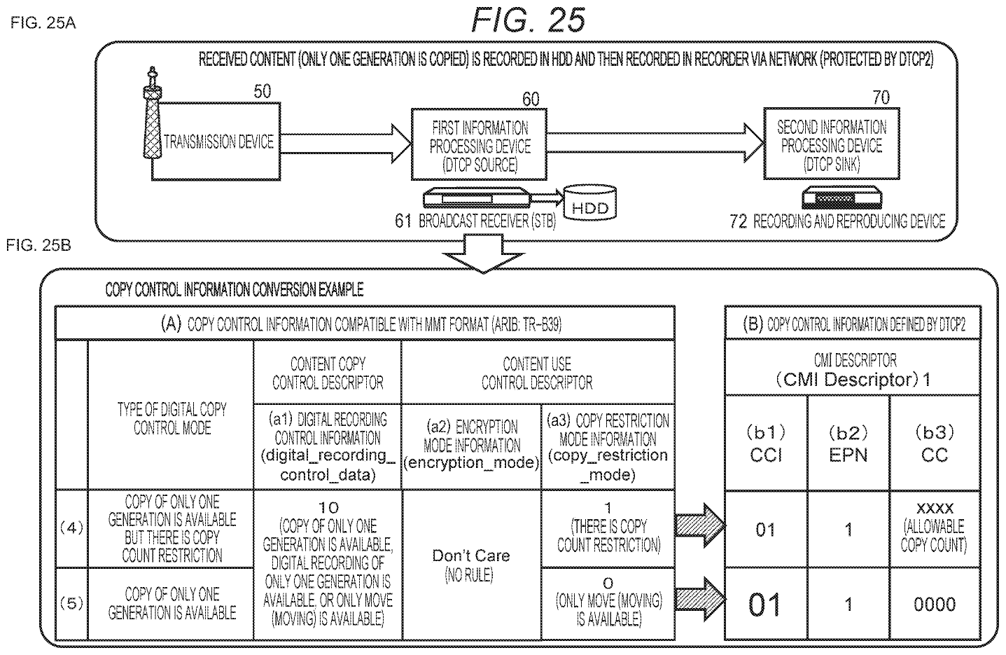

Next, processing example 2 will be described with reference to FIG. 25.

(Processing Example 2) illustrated in FIG. 25 is a processing example in which the first information processing device (DTCP source) 60 receives content in which the copy control information compatible with the MMT format (ATIB TR-B39)=only one generation is copyable from the transmission device 50, the first information processing device (DTCP source) 60 itself records the received content in a medium such as a hard disk, then converts the copy control information into the copy control information compatible with DTCP2, and transmits the converted copy control information to the second information processing device (DTCP sink) 70.

The first information processing device (DTCP source) 60 is, for example, the broadcast receiver (STB) 61, and the second information processing device (DTCP sink) 70 is, for example, the recording and reproducing device (recorder) 72.

FIG. 25(1b) illustrates the extracted entries (4) and (5) of the conversion rules (mapping rules) described above with reference to FIG. 14.

(4) Copy of only one generation is available but there is copy count restriction

(5) Copy of only one generation is available

In a case where the content received by the first information processing device (DTCP source) 60 from the transmission device 50 corresponds to the entry (4) of the conversion rules (mapping rules), that is,

(4) copy of only one generation is available but there is copy count restriction,

each of the set values of (A) copy control information compatible with the MMT format (ARIB: TR-B39) is as follows.

(a1) digital recording control information=10 (copy of only one generation is available and digital recording of only one generation is available);

(a2) encryption mode information=Don't Care (no rule); and

(a3) copy restriction mode information=1 (with copy count restriction).

In this case, the first information processing device (DTCP source) 60 sets the following set values for the copy control information defined by DTCP2:

(b1) copy restriction information (CCI)=01 (copy exceeding an allowable count is not available);

(b2) output data encryption necessity information (EPN)=1; and

(b3) allowable copy count (CC)=xxxx (allowable copy count).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

Note that, for (b3) allowable copy count (CC)=xxxx (allowable copy count), a value obtained by subtracting 1 is recorded according to execution of the recording processing by the first information processing device (DTCP source) 60.

Furthermore, in a case where the content received by the first information processing device (DTCP source) 60 from the transmission device 50 corresponds to the entry (5) of the conversion rules (mapping rules), that is,

(5) copy of only one generation is available, each of the set values of (A) copy control information compatible with the MMT format (ARIB: TR-B39) is as follows.

(a1) digital recording control information=10 (copy of only one generation is available, digital recording of only one generation is available, or only move is available);

(a2) encryption mode information=Don't Care (no rule); and

(a3) copy restriction mode information=0 (only move is available).

In this case, the first information processing device (DTCP source) 60 sets the following set values for the copy control information defined by DTCP2:

(b1) copy restriction information (CCI)=01 (copy exceeding an allowable count is not available);

(b2) output data encryption necessity information (EPN)=1; and

(b3) allowable copy count (CC)=0000 (invalid value).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

As described above, in the present processing example, the first information processing device (DTCP source) 60 itself creates and records a copy of the received content to a recording medium such as an HDD. Therefore, the set value is changed to (b1) copy restriction information (CCI)=01 (copy exceeding an allowable count is not available). Furthermore, (CC) indicating the allowable copy count is set to 0000, which is a setting in which further copy is not allowed.

### Processing Example 3

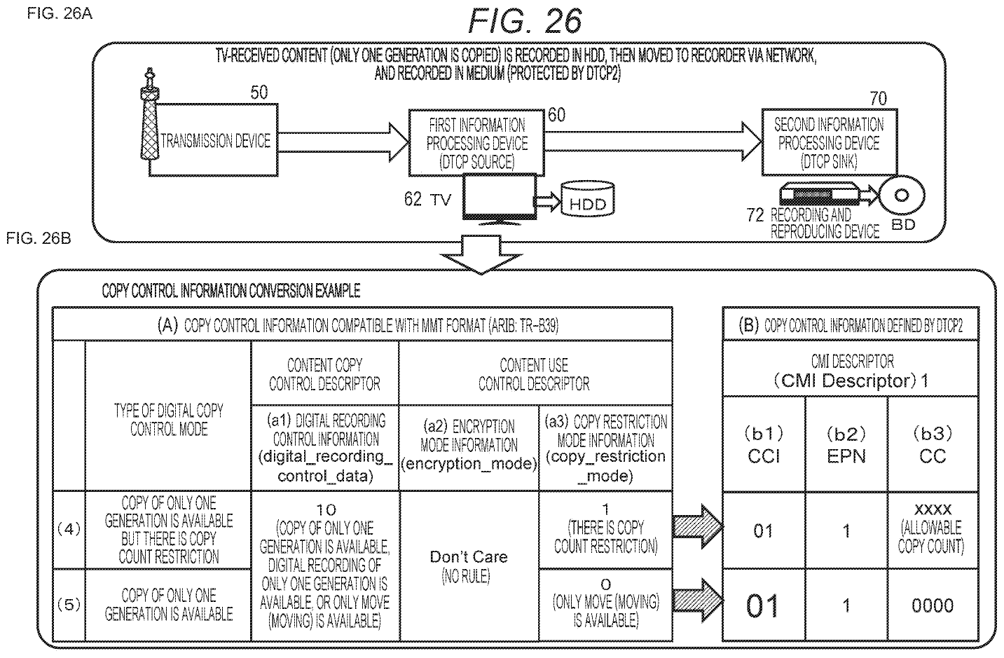

Next, processing example 3 will be described with reference to FIG. 26.

(Processing Example 3) illustrated in FIG. 26 is a processing example in which the first information processing device (DTCP source) 60 receives content in which the copy control information compatible with the MMT format (ATIB TR-B39)=only one generation is copyable from the transmission device 50, the first information processing device (DTCP source) 60 itself records the received content in a medium such as a hard disk and then moves the recorded content to the second information processing device (DTCP sink) 70, and the second information processing device (DTCP sink) 70 records the content in a medium such as a BD.

Note that the move source content is erased by move (moving) processing.

In a case where the content received by the first information processing device (DTCP source) 60 from the transmission device 50 corresponds to the entry (4) of the conversion rules (mapping rules), that is,

(4) copy of only one generation is available but there is copy count restriction,

each of the set values of (A) copy control information compatible with the MMT format (ARIB: TR-B39) is as follows.

(a1) digital recording control information=10 (copy of only one generation is available and digital recording of only one generation is available);

(a2) encryption mode information=Don't Care (no rule); and

(a3) copy restriction mode information=1 (with copy count restriction).

In this case, the first information processing device (DTCP source) 60 sets the following set values for the copy control information defined by DTCP2:

(b1) copy restriction information (CCI)=01 (copy exceeding an allowable count is not available);

(b2) output data encryption necessity information (EPN)=1; and

(b3) allowable copy count (CC)=xxxx (allowable copy count).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

Note that, in the present example, the move (moving) processing has been executed for the content. Therefore, for (b3) allowable copy count (CC)=xxxx (allowable copy count), subtraction processing is not performed according to execution of the processing of erasing the recorded content by the first information processing device (DTCP source) 60.

Furthermore, in a case where the content received by the first information processing device (DTCP source) 60 from the transmission device 50 corresponds to the entry (5) of the conversion rules (mapping rules), that is,

(5) copy of only one generation is available,

each of the set values of (A) copy control information compatible with the MMT format (ARIB: TR-B39) is as follows.

(a1) digital recording control information=10 (copy of only one generation is available, digital recording of only one generation is available, or only move is available);

(a2) encryption mode information=Don't Care (no rule); and

(a3) copy restriction mode information=0 (only move is available).

In this case, the first information processing device (DTCP source) 60 sets the following set values for the copy control information defined by DTCP2:

(b1) copy restriction information (CCI)=01 (copy exceeding an allowable count is not available);

(b2) output data encryption necessity information (EPN)=1; and

(b3) allowable copy count (CC)=0000 (invalid value).

The first information processing device (DTCP source) 60 records the copy control information in the CMI descriptor defined by DTCP2 having the above-described set values and generates the control information storage packet (CMI) 101, and transmits the control information storage packet (CMI) 101 together with content to the second information processing device (DTCP sink) 70.

Note that as described above, CCI=01 means “copy exceeding an allowable count is not available”. In moving, a protocol for move specified by the DTCP2 rule is executed between the DTCP source and DTCP sink, and the DTCP sink records that the received content has been moved.

As described above, in the present example, the first information processing device (DTCP source) 60 moves the received content recorded in the recording medium such as an HDD, the content of the move source is erased, and the copyable state of only one generation becomes effective in the second information processing device (DTCP sink) 70 as the content output destination, and the media recording processing by the second information processing device (DTCP sink) 70 becomes possible.

### Processing Example 4

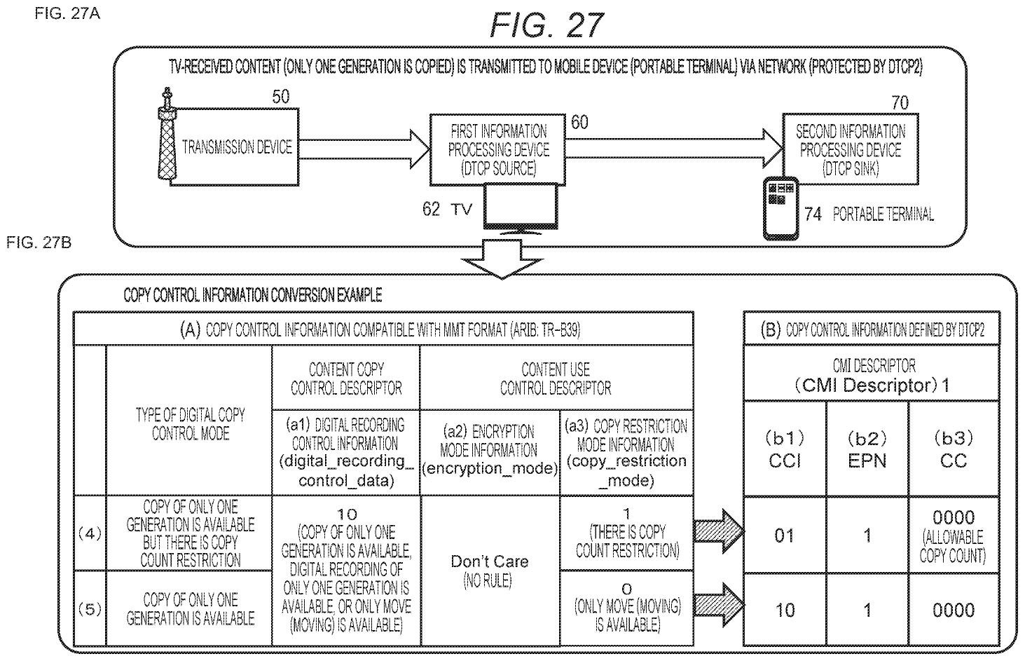

Next, processing example 4 will be described with reference to FIG. 27.

(Processing Example 4) illustrated in FIG. 27 is an example in which the first information processing device (DTCP source) 60 receives content in which the copy control information compatible with the MMT format (ATIB TR-B39)=only one generation is copyable from the transmission device 50, and transmits the content to a mobile device (portable terminal) as the second information processing device (DTCP sink) 70, and a user views the content on the mobile device (portable terminal).

In the present example, the processing of converting the copy control information executed by the first information processing device (DTCP source) 60 is almost similar to (Processing Example 1) described above with reference to FIG. 24.

That is, the mobile device (portable terminal) as the second information processing device (DTCP sink) 70 receives the content together with the copy control information of the following:

(b1) copy restriction information (CCI)=01 (copy exceeding an allowable count is not available);

(b2) output data encryption necessity information (EPN)=1; and

(b3) allowable copy count (CC)=0000 (allowable copy count),

in a case where the content received by the first information processing device (DTCP source) 60 from the transmission device 50 corresponds to the entry (4) of the conversion rules (mapping rules), that is,

(4) copy of only one generation is available but there is copy count restriction.

The difference from the above-described (Processing Example 1) in FIG. 24 is that (b3) allowable copy count (CC) is set to 0000.

In this setting, the mobile device (portable terminal) as the second information processing device (DTCP sink) 70 is not allowed to record (copy) the received content from the first information processing device (DTCP source) 60 but is allowed to reproduce the received content.

Furthermore, in a case where the content received by the first information processing device (DTCP source) 60 from the transmission device 50 corresponds to the entry (5) of the conversion rules (mapping rules), that is,

(5) copy of only one generation is available,

content is received together with the following copy control information:

(b1) copy restriction information (CCI)=10 (copy of only one generation is available);

(b2) output data encryption necessity information (EPN)=1; and

(b3) allowable copy count (CC)=0000 (invalid value).

In either case of the above (4) or (5), the mobile device (portable terminal) as the second information processing device (DTCP sink) 70 can reproduce and view the received content from the first information processing device (DTCP source) 60.

### Processing Example 5

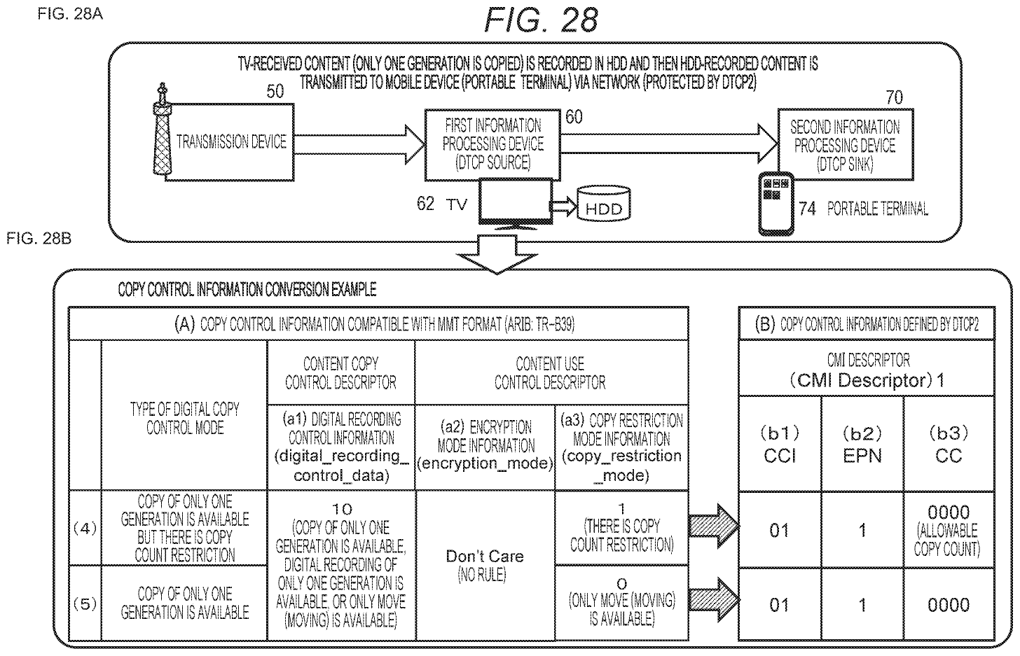

Next, processing example 5 will be described with reference to FIG. 28.

(Processing Example 5) illustrated in FIG. 28 is an example in which the first information processing device (DTCP source) 60 receives content in which the copy control information compatible with the MMT format (ATIB TR-B39)=only one generation is copyable from the transmission device 50, records the content in a medium (HDD or the like) of the first information processing device (DTCP source) 60, transmits the recorded content to a mobile device (portable terminal) as the second information processing device (DTCP sink) 70, and a user views the content on the mobile device (portable terminal).

In the present example, the processing of converting the copy control information executed by the first information processing device (DTCP source) 60 is similar to (Processing Example 4) described above with reference to FIG. 27.

That is, the mobile device (portable terminal) as the second information processing device (DTCP sink) 70 receives the content together with the copy control information of the following:

(b1) copy restriction information (CCI)=01 (copy exceeding an allowable count is not available);

(b2) output data encryption necessity information (EPN)=1; and

(b3) allowable copy count (CC)=0000 (allowable copy count),

in a case where the content received by the first information processing device (DTCP source) 60 from the transmission device 50 corresponds to the entry (4) of the conversion rules (mapping rules), that is,

(4) copy of only one generation is available but there is copy count restriction.

(b3) Allowable copy count (CC) is set to 0000, and the mobile device (portable terminal) as the second information processing device (DTCP sink) 70 is not allowed to record (copy) the received content from the first information processing device (DTCP source) 60 but is allowed to reproduce the received content.

Furthermore, in a case where the content received by the first information processing device (DTCP source) 60 from the transmission device 50 corresponds to the entry (5) of the conversion rules (mapping rules), that is,

(5) copy of only one generation is available,

content is received together with the following copy control information:

(b1) copy restriction information (CCI)=10 (copy of only one generation is available);

(b2) output data encryption necessity information (EPN)=1; and

(b3) allowable copy count (CC)=0000 (invalid value).

In either case of the above (4) or (5), the mobile device (portable terminal) as the second information processing device (DTCP sink) 70 can reproduce and view the received content from the first information processing device (DTCP source) 60.

### Processing Example 6

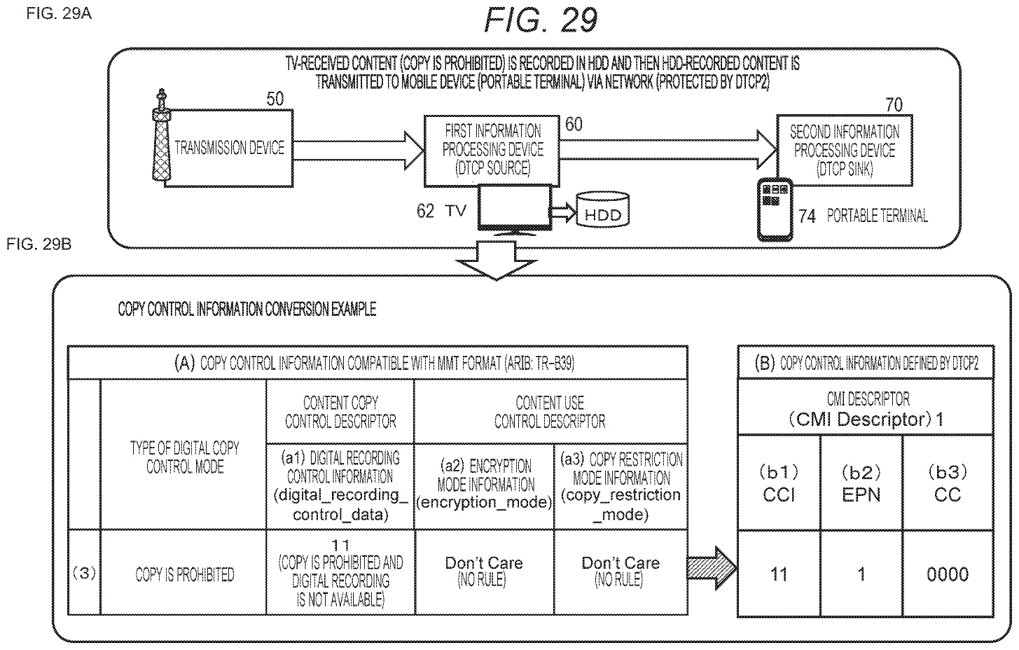

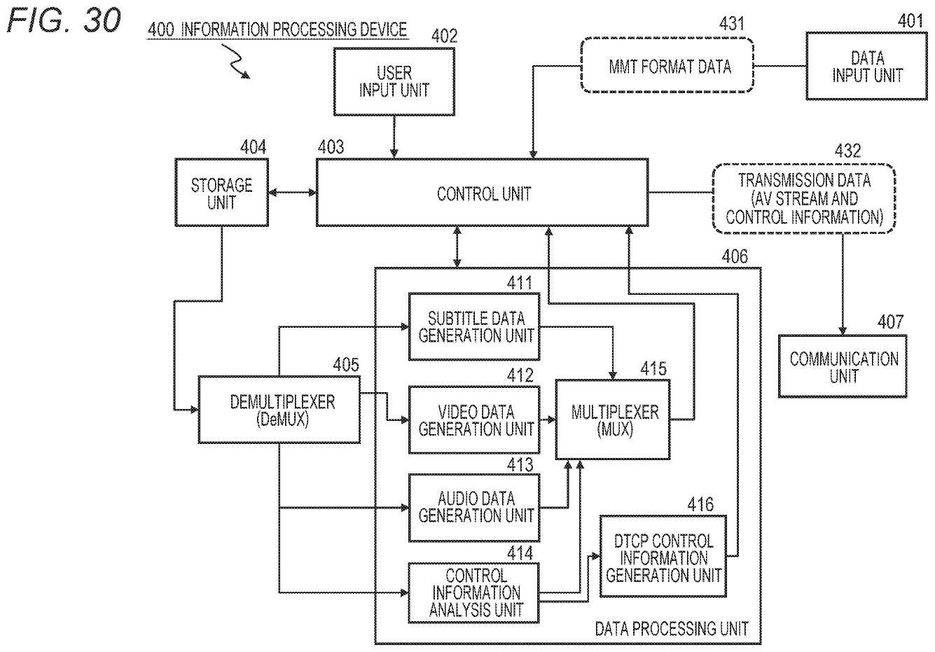

Next, processing example 6 will be described with reference to FIG. 29.

(Processing Example 6) illustrated in FIG. 29 is an example in which the first information processing device (DTCP source) 60 receives content in which the copy control information compatible with the MMT format (ATIB TR-B39)=copy is prohibited from the transmission device 50, records the content in a medium (HDD or the like) of the first information processing device (DTCP source) 60 as temporary retention, transmits the recorded content to a mobile device (portable terminal) as the second information processing device (DTCP sink) 70, and a user views the content on the mobile device (portable terminal).

In this processing example, each of the set values of (A) copy control information compatible with the MMT format (ARIB: TR-B39) in this case is as follows.

(a1) digital recording control information=11 (copy is prohibited and digital recording is unavailable);

(a2) encryption mode information=Don't Care (no rule); and

(a3) copy restriction mode information=Don't Care (no rule).

In this case, the first information processing device (DTCP source) 60 sets the following set values for the copy control information defined by DTCP2:

(b1) copy restriction information (CCI)=11 (copy is not available);

(b2) output data encryption necessity information (EPN)=1; and

(b3) allowable copy count (CC)=0000 (invalid value).

Note that, to output the temporarily retained content, Retention_mode is set to 1.

The mobile device (portable terminal) as the second information processing device (DTCP sink) 70 processes the received content from the first information processing device (DTCP source) 60 according to the above-described copy control information. The mobile device (portable terminal) as the second information processing device (DTCP sink) 70 is not allowed to record (copy) the received content to the medium of its own device but is allowed to reproduce the received content.

[8. Configuration and Processing of Information Processing Device for Executing Data Recording Processing for Information Recording Medium]

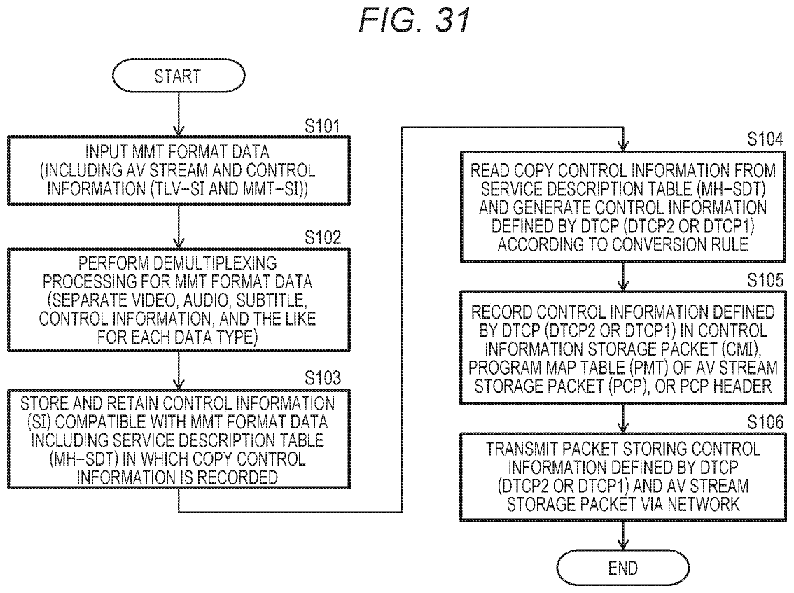

Next, the configuration and processing of the first information processing device (DTCP source) will be described with reference to FIG. 30.

As described above, the first information processing device (DTCP source) executes the processing of inputting data according to the MMT format, converting the content control information such as the copy control information compatible with the MMT format into the content control information defined by DTCP, and transmitting the converted content control information together with the content to the second information processing device (DTCP sink).

The first information processing device (DTCP source) acquires the copy control information included in the input data according to the MMT format, specifically, the copy control information stored in the service description table (MH-SDT) stored in the MMTP packet, and records the content control information defined by DTCP in the control information storage packet (CMI) or the AV stream storage packet (PCP) that is a transmission packet to the second information processing device (DTCP sink).

FIG. 30 is a diagram illustrating a configuration of an information processing device 400 corresponding to the first information processing device (DTCP source).

A data input unit 401 inputs MMT format data 431, that is, MMT format data 431 including video data, audio data, subtitle data, and the like.

The data input unit 401 is configured by a reception unit that receives transmission data from, for example, a broadcasting station or a content server that transmits the MMT format data 431 or a media reading unit that executes data reading from a medium in which the MMT format data 431 is recorded, and the like.

The MMT format data 431 input from the data input unit 401 is data according to the data format described above with reference to FIG. 2, and includes, for example, high-definition video data such as an HEVC image.

The MMT format data 431 is stored in a storage unit 404 under the control of a control unit 403.

A user input unit 402 inputs, for example, a data transmission start request to the second information processing device (DTCP sink).

When the data transmission start request is input from the user input unit 402, the MMT format data 431 stored in the storage unit 404 is input to a demultiplexer (DeMUX) 405 in response to the input as a trigger.

The demultiplexer (DeMUX) 405 acquires the packet in which video, audio, subtitle data, and the like are stored, the notification information, and the control information such as the control information (TLV-SI and MMT-SI) including reproduction control information, the copy control information, and the like from the MMT format data 431, classifies the data into packets by data type, and inputs each of the classified packets to a subtitle data generation unit 411, a video data generation unit 412, an audio data generation unit 413, and a control information analysis unit 414 of a data processing unit 406 according to the data types.

The subtitle data generation unit 411 acquires the subtitle data from MMT format data 331 input by the data input unit 401 and stored in the storage unit 404, and generates stream file storage data defined in a BDAV format.

The video data generation unit 412 acquires the video data from the MMT format data 331 input by the data input unit 401 and stored in the storage unit 404, and generates stream file storage data defined in the BDAV format.

The audio data generation unit 413 acquires the audio data from the MMT format data 431 input by the data input unit 401 and stored in the storage unit 404, and generates stream file storage data defined in the BDAV format.

The control information analysis unit 414 acquires the notification information, and the control information such as the control information (TLV-SI and MMT-SI) including the reproduction control information, the copy control information, and the like from the MMT format data 431 input by the data input unit 401 and stored in the storage unit 404.

A DTCP control information generation unit 416 inputs the content control information such as the copy control information recorded in the service description table (MH-SDT) included in the MMT format data from the control information analysis unit 414, and generates a content control information recording packet compatible with DTCP.

Specifically, in the case where the transmitted content is high-image quality content such as 4K content, 8K content, or an HDR content, the copy control information defined by DTCP2 is recorded in the CMI descriptor described above with reference to FIG. 12 and the control information storage packet (CMI) 101 is generated.

Meanwhile, in the case where the transmitted content is 2K content and is standard dynamic range (SDR) content, the copy control information defined by DTCP1 is recorded in the program map table (PMT) stored in the PCP payload 112 described above with reference to FIG. 17 and the like or the PCP header 111.

A multiplexer (MUX) 415 inputs each of the subtitle, video, and audio data converted by the subtitle data generation unit 411, the video data generation unit 412, and the audio data generation unit 413, and various types of information acquired from, for example, the control information (TLV-SI and MMT-SI) of the MMT format data 331 by the control information analysis unit 414, and generates a packet string storing such data.

Transmission data 432 generated by the data processing unit 406 is transmitted to the second information processing device (DTCP sink) via a communication unit 407 under the control of the control unit 403.

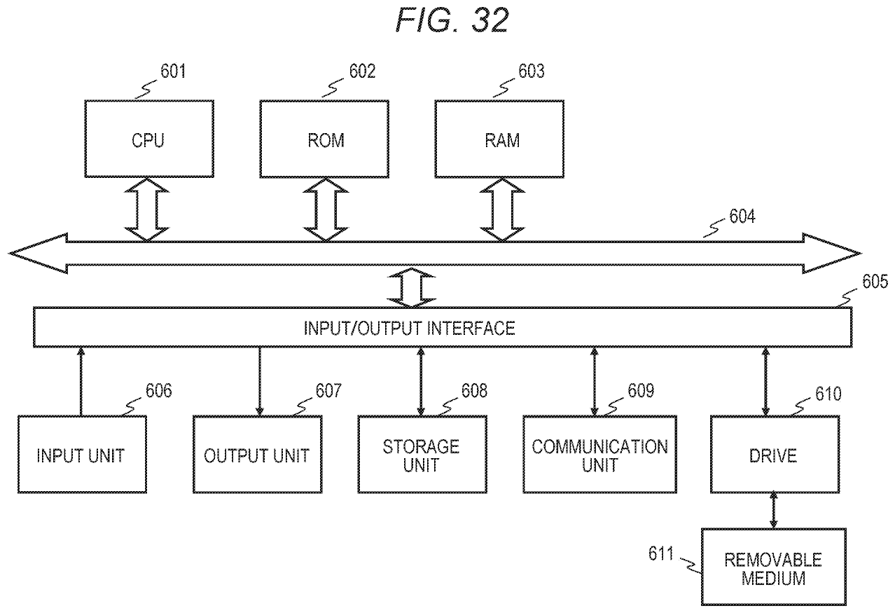

Next, a sequence of the processing executed by the information processing device 400 described with reference to FIG. 30 will be described with reference to the flowchart illustrated in FIG. 31.

The processing according to the flow illustrated in FIG. 31 can be executed, for example, under control of a data processing unit (control unit) including a CPU having a program execution function according to a program stored in the storage unit of the information processing device.

Hereinafter, the processing of each step of the flow illustrated in FIG. 31 will be sequentially described.

(Step S101)

First, in step S101, the information processing device 400 inputs the MMT format data via the data input unit 401.

This data includes, for example, the video data, audio data, subtitle data, and moreover, the control information (TLV-SI and MMT-SI) storing the notification information, control information, and the like.

Note that, as the control information, the copy control information recorded in the service description table (MH-SDT) in the MMT format is included.

(Step S102)

Next, in step S102, the information processing device 400 performs demultiplexing processing for the input MMT format data, that is, data separation processing in units of data type. The information processing device 400 executes the processing of separating videos, audios, subtitles, control information, and the like.

(Step S103)

Next, in step S103, the information processing device 400 stores the control information separated in step S102, such as the control information (TLV-SI and MMT-SI) in a memory.

The control information includes the copy control information recorded in the service description table (MH-SDT) in the MMT format.

(Step S104)

Next, in step S104, the information processing device 400 reads the content control information such as the copy control information recorded in the service description table (MH-SDT) of the MMT format stored in the memory in step S103, and generates the content control information including the copy control information defined by DTCP (DTCP2 or DTCP1).

In the case where the transmitted content for the second information processing device (DTCP sink) is high-image quality data such as 4K or 8K, the information processing device 400 executes, for example, processing of determining the copy control information predetermined by DTCP2 according to the conversion rules (mapping rules) described above with reference to FIG. 14.

Meanwhile, in the case where the transmitted content for the second information processing device (DTCP sink) is normal image quality data such as 2K, the information processing device 400 executes, for example, processing of determining the copy control information predetermined by DTCP1 according to the conversion rules (mapping rules) described above with reference to FIG. 21.

(Step S105)

Next, in step S105, the information processing device 400 generates the packet string including the content control information such as the copy control information generated in step S104.

In the case where the transmitted content is high-image quality content such as 4K content, 8K content, or an HDR content, the copy control information defined by DTCP2 is recorded in the CMI descriptor described above with reference to FIG. 12 and the control information storage packet (CMI) 101 is generated.

Meanwhile, in the case where the transmitted content is 2K content and is standard dynamic range (SDR) content, the copy control information defined by DTCP1 is recorded in the program map table (PMT) stored in the PCP payload 112 described above with reference to FIG. 17 and the like or the PCP header 111.

(Step S106)

Next, in step S106, the information processing device 400 transmits the content control information such as the copy control information defined by DTCP generated in step S105 and the packet including the packet to the second information processing device (DTCP sink).

[9. Configuration Example of Information Processing Device]

Next, a hardware configuration example of the information processing device 400 described with reference to FIG. 31 will be described with reference to FIG. 32.

A central processing unit (CPU) 601 functions as a data processing unit that executes various types of processing according to a program stored in a read only memory (ROM) 602 or a storage unit 608. For example, the CPU 601 executes processing according to the sequence described in the above example. A random access memory (RAM) 603 stores the program executed by the CPU 601, data, and the like. These CPU 601, ROM 602, and RAM 603 are mutually connected by a bus 604.

The CPU 601 is connected to an input/output interface 605 via the bus 604, and an input unit 606 including various switches, a keyboard, a mouse, a microphone and the like, and an output unit 607 including a display, a speaker, and the like are connected to the input/output interface 605. The CPU 601 executes various types of processing corresponding to commands input from the input unit 606, and outputs processing results to the output unit 607, for example.

The storage unit 608 connected to the input/output interface 605 includes, for example, a hard disk and the like, and stores the program executed by the CPU 601 and various data. A communication unit 609 functions as a transmission/reception unit for data communication via a network such as the Internet or a local area network and also functions as a transmission/reception unit of a broadcast wave, and communicates with an external device.

A drive 610 connected to the input/output interface 605 drives a removable medium 611 such as a magnetic disk, an optical disk, a magneto-optical disk, or a semiconductor memory such as a memory card, and executes recording or reading of data.

[10. Conclusion of Configurations of Present Disclosure]

The examples of the present disclosure have been described in detail with reference to the specific examples. However, it is obvious that those skilled in the art can make modifications and substitutions of the examples without departing from the gist of the present disclosure. That is, the present invention has been disclosed in the form of exemplification, and should not be restrictively interpreted. To judge the gist of the present disclosure, the scope of claims should be taken into consideration.

Note that the technology disclosed in the present specification can have the following configurations.

(1) An information processing device including

a data processing unit configured to input MPEG media transport (MMT) format data in which copy control information is set, execute format conversion, and generate transmission data to be transmitted to a network-connected device, in which

the data processing unit acquires the copy control information compatible with the MMT format data included in input data, and generates the transmission data including the copy control information defined by digital transmission content protection (DTCP).

(2) The information processing device according to (1), in which

the data processing unit

generates the transmission data including the copy control information defined by DTCP2 or DTCP1.

(3) The information processing device according to (1) or (2), in which

the data processing unit

generates the transmission data including the copy control information defined by DTCP2 in a case where the transmission data to be transmitted to the network-connected device is data of a 4K image, an 8K image, or an HDR image, and

generates the transmission data including the copy control information defined by DTCP1 in a case where the transmission data to be transmitted to the network-connected device is data of either a 2K image or an SDR image.

(4) The information processing device according to any one of (1) to (3), in which

the data processing unit

acquires the copy control information compatible with the MMT format data from a service description table (MH-SDT) defined by an MMT format.

(5) The information processing device according to any one of (1) to (4), in which

the data processing unit

converts the copy control information compatible with the MMT format data into the copy control information defined by DTCP, and stores the converted copy control information in a control information storage packet configuring a transmission packet to be transmitted to the network-connected device.

(6) The information processing device according to any one of (1) to (5), in which

the data processing unit

converts the copy control information compatible with the MMT format data into the copy control information defined by DTCP, and records the converted copy control information in a program map table (PMT) to be stored in a transmission packet to be transmitted to the network-connected device.

(7) The information processing device according to any one of (1) to (6), in which

the data processing unit

converts the copy control information compatible with the MMT format data into the copy control information defined by DTCP, and records the converted copy control information in a packet header of a transmission packet to be transmitted to the network-connected device.

(8) The information processing device according to any one of (1) to (7), in which

the data processing unit

generates the copy control information defined by DTCP including each of following information:

(a) encryption necessity information of output data; and

(b) information of at least either copy availability information or allowable copy number information.

(9) The information processing device according to any one of (1) to (8), in which

the data processing unit

performs processing of determining each value of copy control information (CCI) that is the copy control information defined by DTCP and defines copy restriction information, and encryption plus non-asserted (EPN) defining encryption necessity information of output data.

(10) The information processing device according to any one of (1) to (9), in which

the data processing unit

executes processing of determining each value of copy control information (CCI) that is the copy control information defined by DTCP and defines copy restriction information, and encryption plus non-asserted (EPN) defining encryption necessity information of output data, according to a predefined conversion rule.

(11) The information processing device according to (10), in which

the conversion rule is

a mapping rule in which the copy control information to be recorded in a service description table (MH-SDT) defined by an MMT format and the copy control information defined by DTCP are associated with each other.

(12) The information processing device according to any one of (1) to (11), in which

the data processing unit

performs processing of determining a value of a copy count (CC) that is the copy control information defined by DTCP and defines an allowable copy count.

(13) An information processing method executed in an information processing device,

the information processing device including

a data processing unit configured to input MPEG media transport (MMT) format data in which copy control information is set, execute format conversion, and generate transmission data to be transmitted to a network-connected device,

the information processing method including

by the data processing unit,

acquiring the copy control information compatible with the MMT format data included in input data, and generating the transmission data including the copy control information defined by digital transmission content protection (DTCP).

(14) A program for causing an information processing device to execute information processing,

the information processing device including

a data processing unit configured to input MPEG media transport (MMT) format data in which copy control information is set, execute format conversion, and generate transmission data to be transmitted to a network-connected device,

the program causing the data processing unit

to acquire the copy control information compatible with the MMT format data included in input data, and generate the transmission data including the copy control information defined by digital transmission content protection (DTCP).

Furthermore, the series of processing described in the description can be executed by hardware, software, or a combined configuration of the hardware and software. In the case of executing the processing by software, a program, in which the processing sequence is recorded, can be installed in a memory of a computer incorporated in dedicated hardware and executed by the computer, or the program can be installed in and executed by a general-purpose computer capable of executing various types of processing. For example, the program can be recorded in the recording medium in advance. Other than the installation from the recording medium to the computer, the program can be received via a network such as a local area network (LAN) or the Internet and installed in a recording medium such as a built-in hard disk.

Note that the various types of processing described in the description may be executed not only in chronological order as described but also in parallel or individually depending on the processing capability of the device that executes the process or as required. Furthermore, the system in the present description is a logical aggregate configuration of a plurality of devices, and is not limited to devices having respective configurations within the same housing.

### INDUSTRIAL APPLICABILITY

As described above, according to the configuration of an embodiment of the present disclosure, the configuration for enabling copy control according to the original copy control information at a data output destination is implemented by converting the copy control information defined in the MMT format data into the copy control information defined by DTCP and transmitting the converted copy control information to a network-connected device.

Specifically, for example, the copy control information defined in the MMT format data is converted into the copy control information defined by DTCP and transmitted to the network-connected device. In the case where the transmission data is any of a 4K image, an 8K image, or an HDR image, and in a case where the copy control information defined by DTCP2 and the transmission data are images are 2K images or SDR images, the copy control information defined by DTCP1 is generated and recorded in a control information storage packet or a program map table (PMT) to be transmitted to a network-connected device, and transmitted.

With the present configuration, a configuration for enabling copy control according to original copy control information at a data output destination is implemented by converting copy control information defined in MMT format data into copy control information defined by DTCP and transmitting the converted copy control information to a network-connected device.

### REFERENCE SIGNS LIST

11 Broadcasting server (broadcasting station)
20 Reception device
30 Network-connected device
50 Transmission device
60 First information processing device (DTCP source)
70 Second information processing device (DTCP sink)
101 Control information storage packet
102 AV stream storage packet
111 PCP header
112 PCP payload
400 Information processing device
401 Data input unit
402 User input unit
403 Control unit
404 Storage unit
405 Demultiplexer
406 Data processing unit
407 Communication unit
411 Subtitle data generation unit
412 Video data generation unit
413 Audio data generation unit
414 Control information analysis unit
415 Multiplexer
416 DTCP control information generation unit
601 CPU
602 ROM
603 RAM
604 Bus
605 Input/output interface
606 Input unit
607 Output unit
608 Storage unit
609 Communication unit
610 Drive
611 Removable medium

1. An information processing device comprising
a data processing unit configured to input MPEG media transport (MMT) format data in which copy control information is set, execute format conversion, and generate transmission data to be transmitted to a network-connected device, wherein
the data processing unit
acquires the copy control information compatible with the MMT format data included in input data, and generates the transmission data including the copy control information defined by digital transmission content protection (DTCP).

2. The information processing device according to claim 1, wherein
the data processing unit
generates the transmission data including the copy control information defined by DTCP2 or DTCP1.

3. The information processing device according to claim 1, wherein
the data processing unit
generates the transmission data including the copy control information defined by DTCP2 in a case where the transmission data to be transmitted to the network-connected device is data of a 4K image, an 8K image, or an HDR image, and
generates the transmission data including the copy control information defined by DTCP1 in a case where the transmission data to be transmitted to the network-connected device is data of a 2K image and of an SDR image or an image having quality lower than the SDR image.

4. The information processing device according to claim 1, wherein
the data processing unit
acquires the copy control information compatible with the MMT format data from a service description table (MH-SDT) defined by an MMT format.

5. The information processing device according to claim 1, wherein
the data processing unit
converts the copy control information compatible with the MMT format data into the copy control information defined by DTCP, and stores the converted copy control information in a control information storage packet configuring a transmission packet to be transmitted to the network-connected device.

6. The information processing device according to claim 1, wherein
the data processing unit
converts the copy control information compatible with the MMT format data into the copy control information defined by DTCP, and records the converted copy control information in a program map table (PMT) to be stored in a transmission packet to be transmitted to the network-connected device.

7. The information processing device according to claim 1, wherein
the data processing unit
converts the copy control information compatible with the MMT format data into the copy control information defined by DTCP, and records the converted copy control information in a packet header of a transmission packet to be transmitted to the network-connected device.

8. The information processing device according to claim 1, wherein
the data processing unit
generates the copy control information defined by DTCP including each of following information:
(a) encryption necessity information of output data; and
(b) information of at least either copy availability information or allowable copy number information.

9. The information processing device according to claim 1, wherein
the data processing unit
performs processing of determining each value of copy control information (CCI) that is the copy control information defined by DTCP and defines copy restriction information, and encryption plus non-asserted (EPN) defining encryption necessity information of output data.

10. The information processing device according to claim 1, wherein
the data processing unit
executes processing of determining each value of copy control information (CCI) that is the copy control information defined by DTCP and defines copy restriction information, and encryption plus non-asserted (EPN) defining encryption necessity information of output data, according to a predefined conversion rule.

11. The information processing device according to claim 10, wherein
the conversion rule is
a mapping rule in which the copy control information to be recorded in a service description table (MH-SDT) defined by an MMT format and the copy control information defined by DTCP are associated with each other.

12. The information processing device according to claim 1, wherein
the data processing unit
performs processing of determining a value of a copy count (CC) that is the copy control information defined by DTCP and defines an allowable copy count.

13. An information processing method executed in an information processing device,
the information processing device including
a data processing unit configured to input MPEG media transport (MMT) format data in which copy control information is set, execute format conversion, and generate transmission data to be transmitted to a network-connected device,
the information processing method comprising
by the data processing unit,
acquiring the copy control information compatible with the MMT format data included in input data, and generating the transmission data including the copy control information defined by digital transmission content protection (DTCP).

14. A program for causing an information processing device to execute information processing,
the information processing device including
a data processing unit configured to input MPEG media transport (MMT) format data in which copy control information is set, execute format conversion, and generate transmission data to be transmitted to a network-connected device,
the program causing the data processing unit
to acquire the copy control information compatible with the MMT format data included in input data, and generate the transmission data including the copy control information defined by digital transmission content protection (DTCP).
